(19) United States
(12) Patent Application Publication
(10) Pub. No.: US 2024/0177256 A1
(43) Pub. Date: May 30, 2024

(54) Adaptive Media Content Supervision Platform

(71) Applicant: Block, Inc., San Francisco, CA (US)

(72) Inventors: Rebecca Sergay, Atlanta, GA (US); Samantha Morgenstern, Sherman Oaks, CA (US); Tait Svenson, Lafayette, CA (US)

(73) Assignee: Block, Inc., San Francisco, CA (US)

(21) Appl. No.: 18/072,244

(22) Filed: Nov. 30, 2022

(51) Int. Cl. G06Q 50/18; G06Q 10/067

(52) U.S. Cl. CPC G06Q 50/184; G06Q 10/067

(57) ABSTRACT

An adaptive media content supervision platform is described. In accordance with the described techniques a request is received from an artist entity to enable access to a media content item of the artist entity. The request includes one or more terms that control access of the media content item. The media content item is listed on the media content supervision platform. A subset of media content items that are available for access are surfaced to a supervisor entity via a user interface. A selection of the media content item for licensing by the supervisor entity is received via the user interface of the media content supervision platform. The selection accepts the one or more terms that control access to the media content item. The media content item and a license for accessing the media content item that includes the one or more terms are provided to the supervisor entity.

### TECHNICAL FIELD

Media content platforms can be implemented as dedicated applications as well as web pages and enable entities to upload media content for access by other entities. Media content platforms fail to provide connections between entities utilizing the platform in a way that efficiently utilizes the resources and data available on the media content platforms.

### BRIEF DESCRIPTION OF THE DRAWINGS

FIG. 1 is a block diagram of a non-limiting example environment, according to an embodiment described herein.

FIG. 2 depicts a non-limiting example of interactions of the media content supervision platform with artist devices or interfaces and supervisor devices or interfaces that obtain media content of the artists for use, according to embodiments described herein.

FIGS. 3-28 depict non-limiting examples of user interfaces of an adaptive media content supervision platform, according to embodiments described herein.

FIG. 29 depicts a procedure in an example implementation of an adaptive media content supervision platform, according to an embodiment described herein.

FIG. 30 depicts a procedure in an example implementation of an adaptive media content supervision platform, according to an embodiment described herein.

FIG. 31 is an example environment with which techniques described herein can be implemented, according to an embodiment described herein.

FIG. 32 is an example environment with which techniques described herein can be implemented, according to an embodiment described herein.

FIG. 33 is an environment associated with a ledger system with which techniques described herein can be implemented, according to an embodiment described herein.

FIG. 34 is an example environment in which the environments of FIGS. 31 and 32 can be integrated to enable payments at the point-of-sale using assets associated with user accounts in the peer-to-peer environment of FIG. 32 with which techniques described herein can be implemented, according to an embodiment described herein.

FIG. 35 is a block diagram showing a system for performing techniques described herein with which techniques described herein can be implemented, according to an embodiment described herein.

### DETAILED DESCRIPTION

Disclosed methods and systems include a platform for a first group of entities (e.g., artists) to enable access to one or more media items (e.g., songs or videos) by a second group of entities (e.g., supervisors, picture editors, directors, composers, etc.). In some implementations, the platform enables predictive analysis of the media items to determine an optimal channel (e.g., social network, streaming platform, etc.) and/or optimal medium (e.g., television, commercials, film, speaker, etc.) for transmission, and associated quality (e.g., streaming, compression, time delay) of the media items as they are rendered on such channels and/or mediums. In some implementations, the platform can use a control signal (e.g., from the channel, from a supervisor, etc.) to change the channel to modify the streaming behavior (e.g., stream a song during holiday season, play only 30 seconds of a song, and so on). In one or more implementations, such predictive analysis of media items enables the platform to provide a recommendation on the quality of media content to provide. The quality of the media content can be determined, for example, based on the channel preference of the artist and/or supervisor. As an example, a lower quality video file may be recommended for licensing via a social network channel (e.g., that streams the compilation), whereas a higher quality video file may be recommended for use in a feature film. Generally, supervisors use authorized media content items (e.g., songs) in media content compilations, such as movies, television, video games, and advertising. For example, a supervisor entity may select a song (or a portion of the song) to enhance a dramatic moment in a media content compilation, such as a movie, television show, or commercial. Many artists would like to license media content to supervisors both because of the licensing revenue received from such agreements as well as the exposure which may occur as a result of the artist's content being included in a media content compilation which may be viewed by a large audience.

Content matching (e.g., between an artist and a supervisor) is typically accomplished on an ad-hoc basis or through standard queries on past data alone. For example, conventional approaches to pair an entity (e.g., a supervisor) with media content and artists are typically done through standard queries, such as by matching query terms to user-provided tags associated with items of media content in a repository. In this conventional approach, if a music supervisor requests media content within a particular genre, media content labeled (e.g., by a source of the content) with a tag corresponding to the particular genre is returned. Alternatively, supervisors may simply connect, via generic communication channels or mediums, with entities (e.g., artists or distributors) they have worked with previously to obtain media content and prepare agreements for suitable content.

These conventional approaches make it difficult for artists, particularly new and unsigned artists, to find supervisors to license the artists' media content and for supervisors to find media content to license from artists. For instance, artists who want to license media content often find it difficult, time-consuming, and imprecise to determine who the right supervisors might be to accomplish varying goals and metrics. Some artists, for example, may want to license media content to increase licensing revenue, while other artists are more concerned with licensing media content to increase the size of the artist's audience as a result of increased exposure received from a popular media content compilation. Thus, locating and connecting with potential supervisors requires an immense amount of data searching and transmissions to facilitate. Moreover, there are no existing data-driven ways for artists to determine which optimal channels (e.g., social network channels) for media content or an optimal medium for media content (e.g., commercials, television, or film). Similarly, supervisors looking for a media content item to license find it difficult to find media content from new or emerging artists due to the vast volume of media content that exists. For example, a supervisor looking for the perfect song for a television show or commercial may listen to hundreds of hours of music with no guarantee that the supervisor will locate the right song for a particular project. Review of such volumes of information by supervisors requires immense amounts of data storage and transmission to facilitate. There are simply no existing data-driven ways for artists and supervisors to match.

Another problem of conventional approaches is that even if an artist and a supervisor want to license a piece of media content, the process of preparing agreements between artists and supervisors may involve the transmission of numerous and ad-hoc communications across various communication channels and/or mediums, e.g., email, phone, text, messenger platforms, etc., in order to establish terms for licensing a media content item or a portion of a media content item to a supervisor. Additional steps then exist to draft an agreement between these entities so that the agreement accurately reflects those terms. This is particularly time-consuming (especially for independent artists) and also can result in wasted communications using channels that are not frequently used by artists and supervisors or this can cause such electronic messages to get lost amongst thousands of unread messages received over various platforms.

To this end, techniques described herein relate to an adaptive media content supervision platform that reduces network traffic and burdens on computer resources by presenting a limited, targeted set of options to supervisors looking for media content to include in a compilation. Additionally, the adaptive media content supervision platform enables new and unique connections to be built between entities (e.g., between artists and supervisors) based on both terms controlling access to the media content as well as characteristics of the media content itself. For example, the adaptive media content supervision platform enables the pairing of entities based on media content characteristics and also based on matching terms (e.g., for licensing the media content). For example, the media content supervision platform provides a sequence of user interfaces which guide an entity (e.g., an artist) through a workflow for selecting media content to make available for licensing and defining terms controlling the types and duration of access that is permitted. In one or more implementations, the media content supervision platform predictively guides the artist's selections of media content items to make available via the supervision platform as well as the terms controlling access to the media content items. For example, the media content supervision platform may use machine learning to surface recommendations to the artist regarding media content items to license as well as recommended data characteristics or terms controlling access to the media content items.

The terms controlling access to the media content items, for example, describe permissions that control access of the media content item, such as by an entity (e.g., a supervisor) that acquires the media content item for use, e.g., the permissions are included as part of and/or define a license for use of the media content item by the supervisor. Examples of permissions which may be selected by the artist and/or recommended by the media content supervision platform include, but are not limited to, an amount of time an entity (e.g., the supervisor) is permitted to use the media content item (e.g., as part of a compilation of media content), one or more locations (e.g., countries, states, cities, or other definable geographic regions) where the entity is permitted to use the media content item, medium of compilation within which the media content item is permitted to be incorporated (e.g., advertisement, video, music video, television series, movie, non-fungible token (NFT), etc.), channels via which a compilation including the media content item is permitted to be surfaced (e.g., various social media channels, video streaming channels, music streaming channels, websites or pages, and so on), subject matter of a compilation within which the media content item is permitted to be incorporated (e.g., political content or alcohol advertising content) and/or within which the media content item is not permitted to be incorporated (e.g., explicit content or content with a certain audience rating), and whether the entity is permitted to “publicly perform” a compilation that includes the media content item, to name just a few.

Similarly, the media content supervision platform may guide a supervisor's selection of media content items. For example, the media content supervision platform may use machine learning to surface recommended media content items that are available for licensing via a user interface. The surfaced media content items selected by the media content supervision platform match characteristics and/or terms specified by the supervisor. For example, the media content supervision platform can indicate to the artist or supervisor which media item, which channel, what kind of quality and which portion of a media item to render on a specific channel. In some cases, the machine learning models may be trained and/or retrained to improve media content recommendations over time based on whether the supervisor selects a media content item for inclusion in a particular compilation, for instance. As such, the described techniques and systems solve problems faced by conventional systems by decreasing the time and manual input required by both artist and supervisors to locate media items that are a fit in terms of content and in terms of licensing with a supervisors' projects.

Moreover, the described techniques and systems reduce the back-and-forth communications of conventional approaches by limiting supervisors to providing input via interactive elements of a user interface. The interactive elements of the user interface enable supervisors to select one or more options for using media content, but the interactive elements exposed to a supervisor correspond to options previously selected by a source of the media content item (e.g., an artist) as being acceptable. This contrasts with conventional approaches where selectable options are not provided via a user interface. Instead, in conventional approaches, entities (e.g., supervisors and artists) come to an agreement (in theory) regarding what are believed to be the terms for licensing a media content item (e.g., via one or more negotiations), exchange drafts of licensing agreements, edit terms with which the entities do not agree, and exchange more drafts and edit them, until a mutual compromise is reached with the licensing agreement. This process, using conventional approaches, can involve numerous communications across various communication channels and storage of numerous versions of a licensing agreement (e.g., drafts). Limiting supervisors and artists to providing control signals (e.g., by selecting surfaced user interface elements) reduces the process of negotiating and generating a license to simply the provision and receipt of those signals. Additionally, in scenarios where a supervisor has already provided control signals defining the type of media content the supervisor is searching for and the terms according to which the supervisor will license such a media content item, the described techniques limit the media content items surfaced to the supervisor to the items that match the supervisor's control signals, further reducing back and forth communications. By reducing the number and ad-hoc nature of communications between such entities, the techniques enable media content item use by an entity (e.g., a supervisor) without the use of, or with a reduced use of computer processing and/or associated time delays relative to conventional back-and-forth communication over various channels and/or mediums. Additionally, bandwidth usage is reduced as a result of the reduction of communication between entities.

The media content supervision platform predictively analyzes the media content items (e.g., using machine learning models) to determine the optimal communication channel or medium to which the media content item can be rendered. For example, some media content items are better suited for specific social platforms and rendered for 30 seconds. Some media content items are better suited for advertisements versus movies. Other media content items are better rendered through streaming, for example, if frame rate and bandwidth is not a concern.

Although the techniques discussed herein are described in relation to “artists” and “supervisors,” the techniques are applicable to other entities, such as to facilitate the licensing of media content between various types of artists and other entities. Example entities for which the described media content supervision platform may be useful include but are not limited to producers, distributors, labels, actors and actresses, athletes, crafts people, personalities, business people, academics, fitness personalities, merchandisers, chefs, restauranteurs, facility or venue owners/managers, fashion designers, influencers, models, and promoters, to name just a few.

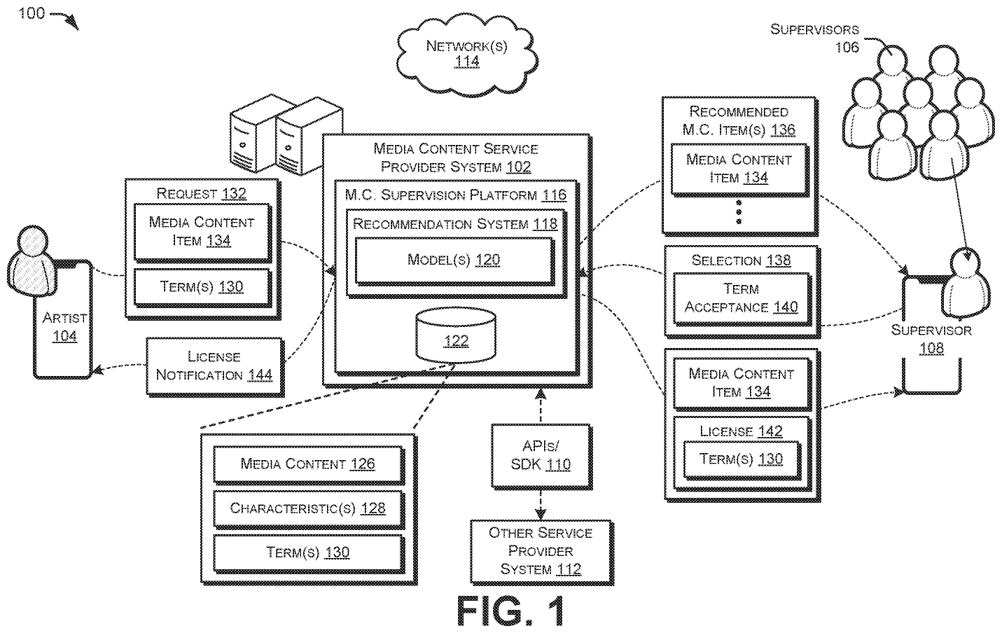

Turning now to the figures, FIG. 1 is a block diagram of a non-limiting example environment 100. In one embodiment, the environment includes a media content service provider system 102 and various users of the service provider system, which include an artist entity 104 (hereafter “artist 104”) of a population of artists entities (not shown) and a population of supervisor entities 106 (hereafter “supervisors 106”), an example of which is supervisor entity 108 (hereafter “supervisor 108”). As described herein, the term artist 104 (or artist entity) and supervisor 108 (or supervisor entity) may correspond to computing devices or interfaces used by the respective artist 104 or supervisor 108. In one or more implementations, the media content service provider system 102, at least in part, surfaces media content (e.g., music) to the supervisors 106, such as media content that has been made available by artists to the supervisors 106 for incorporation into compilations of media content (e.g., television episodes, commercials, movies, inspirational videos, shows, instructional videos, and so forth). In addition to surfacing available media content, the media content service provider system 102 also facilitates licensing media content of an artist 104 to a supervisor 108, e.g., for incorporation into such compilations, as discussed above and below.

Additionally or alternatively, the media content service provider system 102 is a collaboration application communicatively coupled, e.g., through dedicated application programming interfaces (APIs) or software development kits (SDKs) 110 to at least one other service provider system 112 that is or deploys one or more application(s), such as a content creation application (or suite of them), streaming application, lending application, payment application, appointment application, loyalty application, and so on. The artist 104 and the supervisors 106 (including the supervisor 108) access the media content service provider system 102 via one or more computing devices, which execute thereon applications as described herein. In at least one implementation, the artist 104 and the supervisors 106 (including the supervisor 108) have user accounts with the media content service provider system 102. In some cases, one or more of those users have not signed up for user accounts with the media content service provider system 102.

In accordance with the described techniques, one or more users of the media content service provider system 102 are designated as “artists” (e.g., the artist 104), which collectively form a population of artists (not shown). The population of artists generate media content for the media content service provider system 102, for other service providers (e.g., for one or more streaming services), for live performances, and/or for exposure to an audience in various ways.

Regarding communication among the various depicted entities, the artist 104 and the supervisor 108 are depicted with respective computing devices, which represents how they and other users (e.g., other artists and/or other supervisors of the population of supervisors 106) access the functionality of the media content service provider system 102. The devices of the artist 104 and the supervisor 108 can be connected to each other and those of one or more other users (e.g., the supervisors 106 and other artists), along with the media content service provider system 102 and the other service provider system 112 via one or more network(s) 114, an example of which is the Internet.

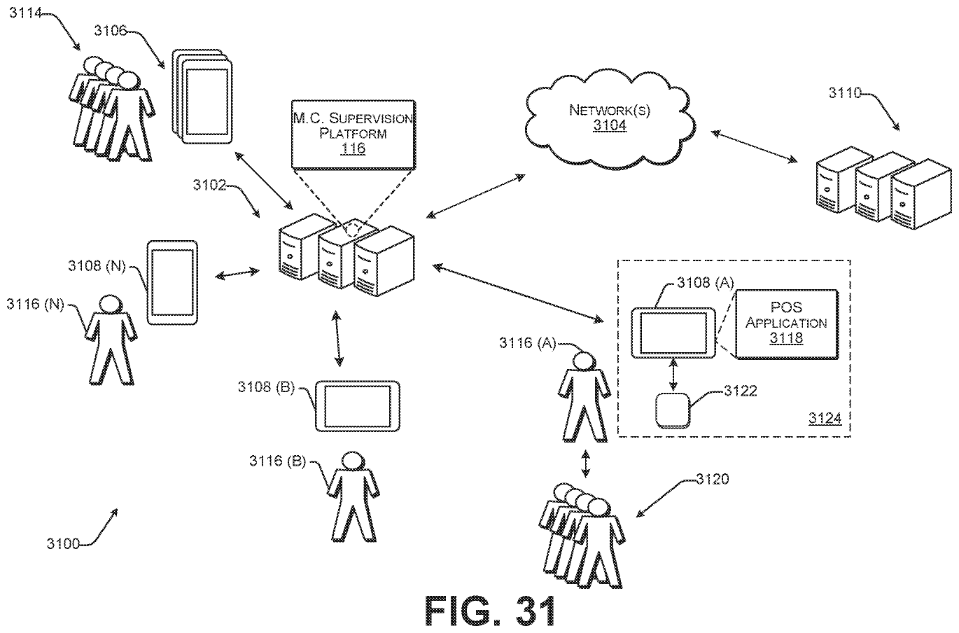

Computing devices that implement the environment 100 are configurable in a variety of ways. A computing device, for instance, is configurable as a server, a desktop computer, a laptop computer, a mobile device (e.g., assuming a handheld configuration such as a tablet or mobile phone), an IoT device, a wearable device (e.g., a smart watch), an AR/VR device, and so forth. Thus, a computing device ranges from full resource devices with substantial memory and processor resources to low-resource devices with limited memory and/or processing resources. Although in instances in the following discussion reference is made to a computing device in the singular, a computing device may also represent any number of different computing devices, such as multiple servers of a server farm utilized to perform operations “over the cloud” as further described in relation to FIG. 31.

The media content service provider system 102 is depicted including media content supervision platform 116 (also referred to in some figures as “M.C. supervision platform 116”), which includes a recommendation system 118 having one or more model(s) 120 and which includes storage 122. The storage 122 is depicted storing media content 126, such as media content of the population of artists to which the artists enable access by other entities, e.g., for incorporation by the supervisors 106 into compilations of media content or for streaming. The storage 122 is also depicted storing characteristic(s) 128 associated with the media content 126 and storing term(s) 130 for licensing the media content 126, which will be discussed in more detail below. The storage 122 may be configured in various ways to store data. For instance, the storage 122 may include or otherwise have access to one or more databases, virtual storage, and so forth.

In one or more implementations, to make media content accessible to the supervisors 106 (e.g., for incorporation into one or more compilations of media content), an artist 104 provides a request 132 to the media content supervision platform 116. The request 132 may be to provide users of the M.C. supervision platform 116 with access to a media content item 134 of the artist 104. In the illustrated example, the request 132 includes term(s) 130, which control use of the media content item, e.g., by the supervisors 106. By way of example, the request 132 may be generated responsive to receiving user input from the artist 104 via a sequence of user interfaces, which guide the artist 104 through a workflow of selecting the media content item 134 (which may correspond to a portion of a media content item in one or more implementations) and defining the term(s) 130 based on selections of one or more user interface controls, as discussed in more detail below.

In one or more implementations, the media content supervision platform 116 predictively guides the artist's selections of media content items to make available via the media content supervision platform 116 as well as the terms controlling access to the media content items. By way of example, the recommendation system 118 may utilize one or more models 120 to analyze the media content item 134 using machine learning to generate one or more recommended terms 130 that control access to the media content item 134. For instance, the models 120 may use information included in the request 132 (e.g., the term(s) 130) and/or characteristics of the media content item 134 itself as inputs to generate recommendations. In some examples, the recommendation system 118 may leverage an encoder (not pictured) to generate a vector representing characteristics of the media content item 134, where the models 120 receive the vector as an input for generating recommendations.

As an example of outputs of the models 120, the recommendation system 118 may generate a recommended amount of time that the supervisor 108 is permitted to use the media content item as part of the compilation of media content (e.g., 6 months, 1 year, or perpetual). As another example, the recommendation system 118 may recommend one or more channels where the supervisor 108 is permitted to use the media content item 134 as part of a compilation of media content (e.g., various social media channels, video streaming channels, music streaming channels, websites or pages, and so on). As another example, the recommendation system 118 may generate one or more recommended mediums that the media content item 134 is permitted to be incorporated (e.g., advertisement, video, music video, television series, movie, non-fungible token (NFT), etc.).

The one or more recommended terms may then be surfaced to the artist 104 via one or more user interfaces for selection by the artist 104. By way of example, the media content supervision platform may surface a recommended period of time of 6 months that a supervisor may utilize the media content item 134 to the artist 104. The artist 104 can then select this recommended period of time to associate this term 130 with the media content item 134.

For example, the media content supervision platform may use machine learning to surface recommendations to the artist regarding media content items to license as well as recommended terms controlling access to the media content items.

The media content supervision platform 116 thus receives the request 132 from the artist 104, and the media content supervision platform 116 enables access to the media content item 134. By way of example, the media content supervision platform 116 lists the media content item 134 on the media content supervision platform 116, such that the media content item 134 is surfaced to client devices of users of the media content supervision platform 116, e.g., users with sufficient permission(s). As used herein, the phrase a user with “sufficient permissions” refers to a user that is associated with one or more permissions which enable the user to perform an action and/or which enable an action to be performed for the user. A user may be associated with such permissions in a variety of ways, such as based on a subscription level with the media content supervision platform 116, a status level (e.g., famousness) of the user, an achievement level of the user in terms of one or more tasks completed and tracked by the media content supervision platform 116, and so on. For example, the media content supervision platform 116 generates a listing of the media content item 134, which is listed on the media content supervision platform 116 with listings for a plurality of other media items, e.g., other media items of the artist 104 and/or other artists. In one or more implementations, the media content supervision platform 116 surfaces various listings (e.g., displays them) to users (e.g., one or more of the supervisors 106) as recommendations, enables users to search the listings for media content items (e.g., by artist, by title, by genre, or other characteristic(s) 128 of the media content items), enables users to browse the listings of media content items, categorizes listings of the media content items, and so forth.

In accordance with the described techniques, the media content supervision platform 116 associates the media content item 134 with one or more of the characteristic(s) 128. Examples of the characteristic(s) 128 include, but are not limited to, artist (e.g., name), title (e.g., of the media content item), description (e.g., as provided by the artist or another entity associated with the artist, such as a manager or agent), genre, instruments, beats per minute, mood, the presence or absence of lyrical content, actual lyrics, subject of the media content (e.g., lyrical or visual subject matter), the presence or absence of instrumental content, length of media content item, format, language, and presence or absence of “explicit” subject matter, to name just a few. In one or more implementations, the media content supervision platform 116 associates the media content item 134 with one or more of the characteristic(s) 128 using one or more machine learning models, such as natural language processing (NLP) models, audio signal processing models, image processing models, and so on. In at least one variation, the media content supervision platform 116 may maintain data (e.g., metadata) and/or implement some mechanism that persists associated characteristics with respective media content items.

Additionally, the media content supervision platform 116 associates the media content item 134 with the term(s) 130, which may include one or more terms in various scenarios and are defined for the media content item 134 based on control signals received from the artist 104, the supervisor 108, or some other source (e.g., the model(s) 120). Broadly, the term(s) 130 control use of the media content item 134, such as by an entity (e.g., a supervisor 108) that acquires the media content item 134 for use, e.g., the term(s) 130 are included as part of and/or define a license for use of the media content item 134 by the supervisor 108. Examples of the term(s) 130 include, but are not limited to, an amount of time an entity (e.g., the supervisor 108) is permitted to use the media content item 134 (e.g., as part of a compilation of media content), one or more locations (e.g., countries, states, cities, or other definable geographic regions) where the entity is permitted to use the media content item 134, medium of compilation within which the media content item 134 is permitted to be incorporated (e.g., advertisement, video, music video, television series, movie, non-fungible token (NFT), etc.), channels via which a compilation including the media content item 134 is permitted to be surfaced (e.g., various social media channels, video streaming channels, music streaming channels, websites or pages, and so on), subject matter of a compilation within which the media content item 134 is permitted to be incorporated (e.g., political content or alcohol content) and/or within which the media content item 134 is not permitted to be incorporated (e.g., sexual content or controlled substance content), and whether the entity is permitted to “publicly perform” a compilation that includes the media content item 134, to name just a few. In one or more implementations, the media content supervision platform 116 associates the term(s) 130 with the media content item 134 responsive to receiving the request 132. For instance, the media content service provider system 102 associates the term(s) 130 with the media content item 134 as part of listing the media content item 134 on the media content service provider system 102, such that a listing of the media content item 134 surfaced to the supervisors 106 includes the term(s) 130. In at least one variation, the media content supervision platform 116 may maintain data (e.g., metadata) and/or implement some mechanism that persists associated terms with respective media content items.

In accordance with the described techniques, the media content supervision platform 116 surfaces one or more media content items to the supervisors 106. For example, the media content supervision platform 116 surfaces listings to the supervisors 106 via an interface of the media content supervision platform 116, where the listings each list a respective media content item made accessible on the media content supervision platform 116 by a respective artist entity (or by an entity associated with the artist entity). For instance, the media content supervision platform 116 surfaces listings for such media content items to the supervisors 106 via a user interface of the media content supervision platform 116 based on the supervisors 106 signing into the media content supervision platform 116, launching or opening an application of the media content supervision platform 116, providing user input via a user interface of the media content supervision platform 116 to recommend media content items for a compilation of media content, providing user input via a user interface of the media content supervision platform 116 to search for media content items for a compilation of media content, and so forth. In the context of interactions with an individual supervisor, consider the following discussion in relation to the supervisor 108.

In accordance with the described techniques, the media content supervision platform 116 may surface recommended media content item(s) 136 (which may be referred to in one or more figures as recommended M.C. item(s) 136) to the supervisor 108. The recommended media content item(s) 136 include the media content item 134 from the artist 104. The recommended media content item(s) 136 may be surfaced to the supervisor 108, for instance, via a user interface of the media content supervision platform 116 and responsive to various actions of the supervisor 108 with the media content supervision platform 116, such as one or more of the actions described above, e.g., opening an application, requesting a recommendation of media content items, searching for media content items, and so on.

Alternatively or in addition, the media content supervision platform 116 may process data associated with the supervisors 106 and/or the artist 104 and, based on the processing, generate and surface the recommended media content item(s) 136 automatically (e.g., without input from a supervisor), such as based on the data indicating satisfaction of one or more thresholds. Examples of such thresholds include an amount of time without interacting with the platform, a “freshness score” related to how recent the media content item is, a number of times media content items have been recommended to other supervisors for compilations of media content or other media content projects, a threshold amount of consumption of an artist's media content (e.g., above or below the threshold), a prediction that generating a compilation of media content that includes the media content item 134 of the artist 104 (and/or other artists) will likely result in a metric (e.g., number of views of the compilation) that satisfies a threshold, and so forth. As an example of surfacing recommended media content items based on a threshold amount of consumption, the media content item 134 may be surfaced to the supervisor 108 based on consumption of the media content item 134 being greater than a certain number of streams (e.g., 100,000 streams) over a duration of time (e.g., the preceding month). Recommended media content item(s) 136 may be communicated to supervisors 106 from the media content supervision platform 116 or generated automatically responsive to a variety of triggers without departing from the spirit or scope of the described techniques.

The media content supervision platform 116 may surface notifications to devices of the supervisors 106 without receiving an explicit request for media content items for use in compilations in a variety of other instances as well, such as a “match score” between an artist and a supervisor being above a threshold score, where the match score may correspond to one or more of a popularity of the artist and/or the supervisor, a genre of the artist and genres or mediums of compilations of a supervisor, a likelihood of the supervisor to use media content items of other artists in compilations, and so on. The media content supervision platform 116 may provide a notification recommending media content items in a web browser or an application associated with the media content supervision platform 116 executing on a device of a supervisor, as a push notification, and so forth. The media content supervision platform 116 may provide a notification recommending media content items in other ways without departing from the spirit or scope of the described techniques, such as via an automated voice message, a text message, an email, and so forth.

In one or more implementations, the recommended media content item(s) 136 are generated using the model(s) 120 of the recommendation system 118. In one or more implementations, the recommendation system 118 determines a variety of underlying data that is associated with a context in which a recommendation is surfaced to a supervisor and generates a representation (e.g., a fingerprint) which encodes the underlying data. For instance, the “fingerprint” is a vector object or some other latent representation which encodes the underlying data and is capable of serving as input to the model(s) 120. By way of example, the underlying data associated with providing a recommendation includes, but is not limited to, supervisor data, compilation data (e.g., describing the compilation being created by the supervisor 108 and/or previously created compilations associated with the supervisor), artist data, audio, and video data. In one or more implementations, this underlying data is obtained through a capture device, an example of which is a computing device of the supervisor 108, which may track activity of the supervisor 108, such as across different communication channels (e.g., text, email, computer applications, calendar, social networks, an application of the media content supervision platform 116) that can indicate a purpose or sentiment associated with obtaining a media content item, using a camera of the computing device, using location tracking capabilities of the computing device, using sound capturing an interpretation functionality of the computing device, using touch and/or gesture tracking functionality of the computing device, and so forth. This fingerprint can be compared with one or more fingerprints in a database which represent media content (or portions of media content) to identify a match, e.g., at the time when the fingerprint is generated. Matches need not be exact in various implementations, due to differences in levels, extraneous noise, imprecise or uncorrelated start times, etc., but may be considered to be matching if the two fingerprints correspond above a threshold. In other implementations, the recommendation system 118 may compare the generated fingerprint to other fingerprints over a prior period, such as a five-minute period. The recommendation system 118 may use any type of analysis to compare fingerprints, including principle component analysis (PCA), Latent Dirichlet allocation (LDA), or any other such statistical analysis methods. In some implementations, the recommendation system 118 may generate match scores for the match of a supervisor fingerprint to each other fingerprint in the database, and identify as matching a fingerprint with a highest match score. In a further implementation, the recommendation system 118 may adapt match scores based on historical data associated with a client device of the supervisor 108, such as based on communications happening on a communication channel or other actual collaborations between the supervisor 108 and other supervisors, between the supervisor 108 and collaborators on the compilation (e.g., editors), the supervisor 108 and direct communications with various artists. Examples of actual communications which may be described by historical data to determine a match include but are not limited to liking a post or responding to a message, sentiment(s) of one or more messages (e.g., positive, neutral, or negative) between the supervisor 108 and other entities using natural language processing, etc.

In one or more implementations, the recommendation system 118 determines which media content items of the media content 126 to recommend to the supervisor 108 (e.g., including the media content item 134 of the artist 104) by using the model(s) 120. In one or more implementations, the model(s) 120 include one or more machine learning models, examples of which include neural networks, natural language-based models, regression models, graph networks, convolutional neural networks, reinforcement learning models, classifiers, autoencoders, structured models, unstructured models, and so on. The model(s) 120 may be configured as, or include, other types of models without departing from the spirit or scope of the described techniques. These different models may be built or trained (or the models otherwise learned), respectively, using different data and different algorithms due, at least in part, to different architectures and/or learning paradigms.

Which of the model(s) 120 are used to generate the recommended media content item(s) 136 may depend at least in part on a context of surfacing a recommendation to the supervisor 108. For example, the supervisor 108 may specify one or more characteristics or terms of media content that the supervisor 108 is searching for to use in a compilation, such as a type of compilation the supervisor 108 is assembling. For instance, the supervisor 108 may specify that a reason media content is requested to improve or satisfy a performance metric (e.g., number of views, obtain a threshold conversion, increase in an amount of traffic (e.g., online or physical), and so forth. As noted above, the recommended media content item(s) 136 may be surfaced to the supervisor 108 automatically and without express user input to do so, and in such cases, a context of the recommendation may be different than if expressly requested by the supervisor 108. Regardless, the supervisor may wish to use media content in one or more compilations for various reasons without departing from the spirit or scope of the described techniques, and the media content supervision platform 116 may expose a user interface to the supervisor 108 which allows them to specify one or more reasons or various factors for seeking a media content for use in such a compilation. In some examples, a request for recommended media content items may include one or more natural language inputs indicating reason(s) that the supervisor 108 is looking for media content items, and the model(s) 120 may be configured in such cases to parse and interpret the natural language input using natural language processing to match items of the media content 126 with the supervisor 108, e.g., using “fuzzy matching.” The model(s) 120 selected for use to generate the recommended media content item(s) 136, from the available model(s) 120, may be based on the specified reasons or other reasons, such as a medium of compilation, genre of the compilation, and so on.

As input, the model(s) 120 may be configured to receive a variety of data to generate the recommended media content item(s) 136. To this end, the model(s) 120 may also be trained using a variety of data. For example, the model(s) 120 may be configured to receive and trained using the media content 126, the characteristic(s) 128, and/or the term(s) 130. For example, the model(s) 120 may be trained based on sound characteristics. In this way, the model(s) 120 may be trained to determine sounds that are similar to input sounds (e.g., from music selected by the supervisor 108 as a search query), sounds that match input search terms, sounds that are complementary with a sample compilation or previous compilations provided the supervisor 108, sounds that if combined with a partial compilation of the supervisor 108 would yield a compilation similar to commercially successful compilations or would yield a compilation that an audience (e.g., one or more market segments) is predicted to like, and so forth. Alternatively or in addition, the model(s) 120 may be trained based on term acceptance, e.g., whether the supervisor 108 and/or other supervisors 106 have accepted various terms historically. Accordingly, such a model may predict terms that the supervisor 108 (or one of the supervisors 106) is likely to accept in connection with a given compilation. In one implementation, an affinity engine (not shown) can be used to determine similarity with the supervisor 108 to generate a list of similar supervisors 106, artists, media content items, genres, or terms, e.g., based on the supervisor's ratings of items of the media content 126, historical preferences, media content use data (e.g., use of previous media content items in compilations), and/or explicit and/or implicit user behavior. Additionally, in one embodiment, an affinity calculation can create exclusion rules, e.g., ignore from the list the top N most popular media content items (or artists, albums, genres) when calculating a similarity between a supervisor and a media content item and/or artist. In the same vein, the affinity engine can create preference rules, e.g., to accept certain artists who provide supervisor-friendly terms with media content items and/or have provided media content items which have been observed in use with successful compilations (in terms of one or more performance metrics). The affinity engine, in one embodiment, can additionally or alternatively, approach affinity by highlighting the dissimilarities, e.g., instances where a supervisor has never used a media content item of an artist.

Additionally or alternatively, during training of the model(s) 120, editorial pairs of a compilation and an incorporated media content item, where the compilation includes the incorporated media content item, may be used as a ground truth for the recommended media content item(s) 136 provided by the model(s) 120, such that during training the outputs of the model(s) 120 are compared to the pairs. In one or more implementations, the editorial pairs may include historical compilations, pairs recommended by “experts” in the artistic field (e.g., managers, label heads, producers, etc.). Such editorial pairs may correspond to “acceptable” pairs of compilations and incorporated media content items, e.g., the compilations that have met the streaming metrics set by the supervisor or artist or a third party and/or recommended by artistic experts. Thus, during training, the output of the model(s) 120 may be “rewarded” when the output corresponds to acceptable pairs, such as by adjusting internal weights of the models to encourage such output and/or reinforce underlying policies (e.g., of a reinforcement model). The training may also use “unacceptable” pairs of compilations and incorporated media content items during training. For example, when the output of the model(s) 120 corresponds to unacceptable pairs of compilations and incorporated media content items during training, the model(s) 120 may be “penalized,” such as by adjusting the internal weights to discourage such output and/or to penalize the underlying policies (e.g., of a reinforcement model). The training data comprising “unacceptable” pairs may include compilations that did not meet the streaming metrics, compilations indicated as unacceptable by artistic experts, and so forth. In one or more implementations, the output of the model(s) 120 is compared during training to training data which comprises acceptable and unacceptable pairs of compilations and incorporated media content, where pairs of the compilations and incorporated media content in the training data may be labeled as such, e.g., “acceptable” or “unacceptable”.

In one or more implementations, relevancy scores output by the model(s) 120 correspond to a predicted likelihood that use of the media content item 134 by the supervisor 108 in a compilation of media content (not shown) would produce some number of views, downloads, steams, amount of conversion, etc. of the compilation. In at least one variation, higher relevancy scores (e.g., 1, or closer to 1) indicate a prediction that use of the media content item 134 by the supervisor 108 in a compilation will result in more views, downloads, streams, amount of conversion, etc., and lower relevancy scores (e.g., 0, or closer to 0) indicate a prediction that use of the media content item 134 by the supervisor 108 in a compilation will result in fewer views, downloads, streams, amount of conversion, etc. In one or more implementations, the recommendation system 118 uses the model(s) 120 to generate a relevancy score for one or more media content items associated with term(s) 130 that do not prevent use of the respective media content item for one or more uses specified by the supervisor 108 in connection with a given compilation. For example, the recommendation system 118 may deterministically remove from consideration media content items having terms that specify a shorter amount of time for use than the supervisor 108 specifies is desired in connection with a compilation. This prevents items of the media content 126 that do not satisfy one or more threshold metrics from being recommended to the supervisor 108. The one or more media content items recommended to the supervisor 108 in the recommended media content item(s) 136 may be further filtered. For example, the one or more media content items recommended to the supervisor 108 may be filtered by selecting a number of top media content items (e.g., the top 3 media content items on relevancy scores, the top 5 media content items based on relevancy scores, and so forth), by selecting media content items that satisfy a threshold relevancy, and so forth. Those media content items are then included in the recommended media content item(s) 136 and surfaced to the supervisor 108, e.g., via a user interface.

In accordance with the described techniques, the supervisor 108 provides a selection 138 of the media content item 134 via a user interface. This may include term acceptance 140, which accepts the term(s) 130 associated with the media content item 134. In one or more implementations, the selection 138 and/or the term acceptance 140 are received via a user interface of the media content supervision platform 116 (or a series of them), as described in more detail below. In at least one variation, the user interface presents various terms or a range of terms for the media content item 134 that the artist 104 indicated are acceptable for use of the media content item 134. By way of example, the artist 104 may specify via a user interface of the media content supervision platform 116 that use of at least a number of months (e.g., 3-months) is permitted, and the media content supervision platform 116 may present via a user interface to the supervisor 108 numerous options for using the term for the number of months or longer (e.g., 3-month use, a 6-month use, 12-month use, unlimited time use, and so on). In this example, the supervisor 108 may be able to accept any of the plurality of options, each of which are acceptable under the term(s) 130 specified by the artist 104. Accordingly, the selecting one of these options may correspond to acceptance of at least one of the term(s) 130. Indeed, the supervisor 108 may accept the term(s) 130 specified by the artist 104 for the media content item 134 in a variety of ways without departing from the spirit or scope of the techniques described herein. Once transmitted over the network(s) 114, the media content supervision platform 116 thus receives the selection 138 of the media content item 134 along with the term acceptance 140.

Based on this, the media content supervision platform 116 generates a license 142 for the media content item 134 which includes the term(s) 130. In particular, the license 142 is generated by the media content supervision platform 116 to permit the supervisor 108 (or an entity corresponding to the supervisor) to use the media content item 134 according to the term(s) 130 of the license 142. The media content supervision platform 116 provides the license 142 to the supervisor 108. For example, the media content supervision platform 116 communicates a document and/or some other digital mechanism (e.g., a smart contract) corresponding to the license 142 to the supervisor 108. Alternatively or additionally, the media content supervision platform 116 presents the license 142 (and/or terms of the license) to the supervisor 108 via a user interface. Thus, the supervisor 108 receives access to the media content item 134 of the artist 104 (e.g., for use in a compilation of media content items) from the media content supervision platform 116, along with the license 142 which meets the term(s) 130 specified by the artist 104 for using the media content item 134.

The illustrated example also includes license notification 144. In one or more implementations, the media content supervision platform 116 provides the license notification 144 to the artist 104. The license notification 144 indicates that the media content item 134 has been licensed, e.g., to the supervisor. In at least one variation, the media content supervision platform 116 provides a dashboard (e.g., via a user interface) to the artist 104, which provides a status of one or more of the artist 104's media content items (e.g., in terms of licensing). By way of example, the media content supervision platform 116 provides a dashboard that lists the media content items which the artist has requested to list on the media content supervision platform 116, e.g., as being available for one or more supervisors 106 to use in compilations. In one or more implementations, the dashboard may also indicate media content items of the artist 104 which are electronically visible (e.g., known) to the media content supervision platform 116 but are not listed for use. Such a dashboard may provide various information about the status of listed items, examples of which include an indication of whether a media content has been licensed by a supervisor, a number of supervisors licensing the media content item, a number of licenses for the item, an amount of money obtained as a result of licenses generated for the media content item, expirations of licenses for a media content item, a popularity of a media content item for licensing, a prediction or rating of how a media content item would perform if made available for licensing and/or if terms for the item were changed (e.g., to be less stringent), recommendations for adjusting terms, recommendations for licensing different portions of a media content item (e.g., if a limited portion of the media content item is licensed), and so forth. In the context of users of the media content supervision platform 116 that are permitted to list media content 126 with the media content supervision platform 116, such that media content is surfaced, e.g., to the supervisors 106 consider the following discussion.

In one or more implementations, in order for a user to become designated as an artist 104 with the media content service provider system 102, the user first onboards or “registers” with the media content service provider system 102. To register to become an artist 104, for instance, a user may provide registration data to the media content service provider system 102. The media content service provider system 102 may limit which users are qualified to be designated as artists based on the registration data. In one or more instances, for example, the media content service provider system 102 may deny a user permission to access the media content supervision platform 116 based on the registration data and, as a result of such denial, the media content service provider system 102 may not designate the user status as an artist.

In one or more implementations, the media content service provider system 102 includes an access control system (not shown) to ensure identity verification with respect to the user, and confirm that a user registering to become an artist “is who they say they are,” which may include provision of various information such as social media accounts, email addresses, personally identifying information, biometric information, and so forth. If, based on the review of the registration data, the access control system determines that the user is “who they say they are” the media content service provider system 102 may allow the user to be designated as an artist. In short, for example, the media content service provider system 102 may allow the user to be designated as an artist as long as the user meets one or more acceptance criteria, e.g., based on artist preferences and permissions to be included in the collaboration platform, based on likelihood that an artist may be interested in collaboration (such as above 50% likelihood), based on a likelihood that at least one of the supervisors 106 will be interested using media content from the artist, and so on. In one or more implementations, the media content service provider system 102 may also implement various criteria to limit the population of artists to actual artists, such as by requesting users to provide one or more samples of media content they produced or performed, one or more reviews, and so forth.

The media content service provider system 102 may thus grant a user that meets the criteria for becoming an artist permission to access functionality of the media content supervision platform 116 or permission to access a portion of functionality of the media content supervision platform 116. For instance, lesser-known artists may be granted permission to access a subset of the total functionalities of the media content supervision platform 116, whereas more well-known artists are granted permission to access all of the total functionalities or a subset with more of the total functionalities. Alternatively or in addition, some functionality may be withheld from an artist entity until the artist entity satisfies some threshold, at which point a larger number of the functionalities are “unlocked” for the artist. The locking and unlocking of functionalities translates into making parts of those functionalities visible or invisible (or visible but with a locked status and indicating specific steps that the artist needs to take to unlock) via a graphical user interface of the media content service provider system 102 or the at least one other service provider system 112. In one or more implementations, there may be tiers of functionality to unlock at varying thresholds. For example, if media content of an artist is licensed for use more than a threshold number of times (e.g., 5 times) by one or more of the supervisors 106 in a threshold period of time (e.g., a year), the artist can then have its media content surfaced to a wider range of supervisors, with the supervisors being subject to tighter controls on use of the media content as an example. The functionalities made available and/or exposed to an artist (e.g., visible and locked) can also be modified based on the dynamic nature of an artist's listener data, where functionalities are both added and removed on a periodic basis. In some implementations, an artist can provide specific data, such as identity verification data, concert date and/or ticket information, performance videos, and so on, to further unlock or even access the media content supervision platform 116.

However, if based on review of the registration data, the access control system determines that the user is not “who they say they are” the media content service provider system 102 may deny the user designation as an artist. Moreover, in one or more implementations, the media content service provider system 102 may also include functionality to notify the actual artist or person that an imposter is attempting to register as the actual artist or person on the media content supervision platform 116. This can prevent fraud, intellectual property infringement (or theft), security vulnerabilities, and so on. Manners in which the media content service provider system 102 may inform the actual artist or person include, but are not limited to, email, phone, social media messaging, text, and so forth. In the context of communication flow between the artist 104, the media content supervision platform 116, and the supervisor 108, consider the following discussion.

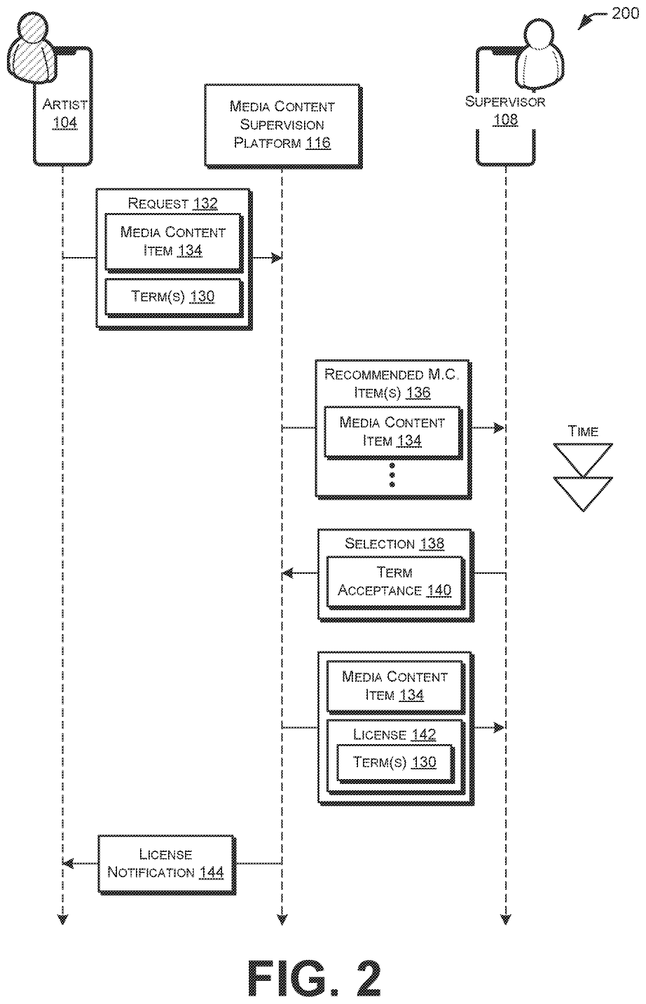

FIG. 2 depicts a non-limiting example 200 of interactions of the media content supervision platform with artist devices or interfaces and supervisor devices or interfaces that obtain media content of the artists for use, according to embodiments described herein.

The example 200 includes a variety of example electronic communications and interactions (including control signals provided) between the artist 104, the media content supervision platform 116, and the supervisor 108 over time. In this example 200, the electronic communications and interactions are positioned vertically based on time (illustrated on the righthand portion of the example), such that electronic communications and interactions closer to a top of the example occur prior to electronic communications and interactions further from the top of the example. It follows also that electronic communications or interactions closer to a bottom of the example occur subsequent to electronic communications and interactions further from the bottom. Additionally, the electronic communications between the artist 104 and the media content supervision platform 116 and between the supervisor 108 and the media content supervision platform 116 are conducted using client devices of the artist 104 and the supervisor 108, such as by using smart watches, mobile phones, laptops, or desktop computers of the artist 104 and the supervisor 108.

In this example 200, the artist 104 is depicted providing and the media content supervision platform 116 is depicted receiving the request 132 to enable access to the media content item 134 along with control signals that define term(s) 130 for controlling use of the media content item 134. As discussed above and below, the request 132 may be received by the media content supervision platform 116 based on user input of the artist 104 via a user interface of the media content supervision platform 116 (or a series of user interfaces), such as control signals to specify the media content item 134 and/or define one or more of the term(s) 130. In one or more implementations, the media content supervision platform 116 may subsequently list the media content item 134, such that the listing enables the media content item 134 to be accessed via the media content supervision platform 116. The media content supervision platform 116 may also provide control signals which control distribution of the media content item 134, and those control signals associate the media content item 134 with one or more characteristic(s) 128 of the media content item 134 and the term(s) 130 specified in the request 132.

In some embodiments, the platform 116 includes options to identify media content items to synchronize with another media content item or compilation. A supervisor interface can set a time stamp for various cues and then generate control signals to specify the kind of media content item (e.g., with specific terms and/or characteristics) to play at those time stamps. The supervisor interface can also preview a media compilation with the suggested media content item 136. For example, the platform 116 may specify for a particular video that time stamp 1:20-2:40 are designated as a cue where music is to be inserted. In some embodiments, the supervisor interface can capture a time stamp for a specific media compilation and then export that time to the artist interface (with specifications of characteristics of the media compilation) to find matching artist media content item.

Subsequent to the request 132, the media content supervision platform 116 is depicted providing and the supervisor 108 is depicted receiving the recommended media content item(s) 136, which include the media content item 134. By way of example, the media content supervision platform 116 surfaces the recommended media content item(s) 136 to the supervisor 108 via one or more user interfaces. In one or more scenarios, the recommended media content item(s) 136 are a subset of the media content 126 items that artists provide control signals to request be made available for access via the media content supervision platform 116. As discussed above, the recommended media content item(s) 136 that are surfaced to the supervisor 108 may be determined using one or more of the model(s) 120 of the recommendation system 118, such as based on characteristics of the supervisor 108 and/or based on characteristics of a compilation for which the supervisor 108 is looking for a media content item.

The supervisor 108 is then depicted providing and the media content supervision platform 116 is depicted receiving a selection 138 of the media content item 134 for licensing. In at least one variation, the selection 138 involves providing one or more control signals which signal term acceptance 140 of the term(s) 130, which are used to control access of the media content item 134 and were defined based on control signals from the artist 104 to control use of the media content item 134. Based on the control signals which produce the selection 138, the media content supervision platform 116 is configured to generate the license 142 which permits use of the media content item 134 under the term(s) 130. In other words, the media content supervision platform 116 generates the license 142 to include the term(s) 130 specified through the control signals which result in the term acceptance 140.

After generation of the license 142, the media content supervision platform 116 provides and the supervisor 108 receives the license 142 with the term(s) 130. Along with the license 142, the media content supervision platform 116 also provides and the supervisor 108 receives the media content item 134 and/or access to the media content item 134 for use, e.g., in a compilation. In one or more implementations, for example, the supervisor 108 downloads the media content item 134 from the media content supervision platform 116 or receives the media content item 134 in a different type of communication, e.g., an email.

In one or more implementations, the media content supervision platform 116 provides and the artist 104 receives a license notification 144, e.g., based on providing the media content item 134 and the license 142 to the supervisor 108. For example, the artist 104 receives a notification via an application of the media content supervision platform 116, e.g., on a home screen of a client device or when opening the application.

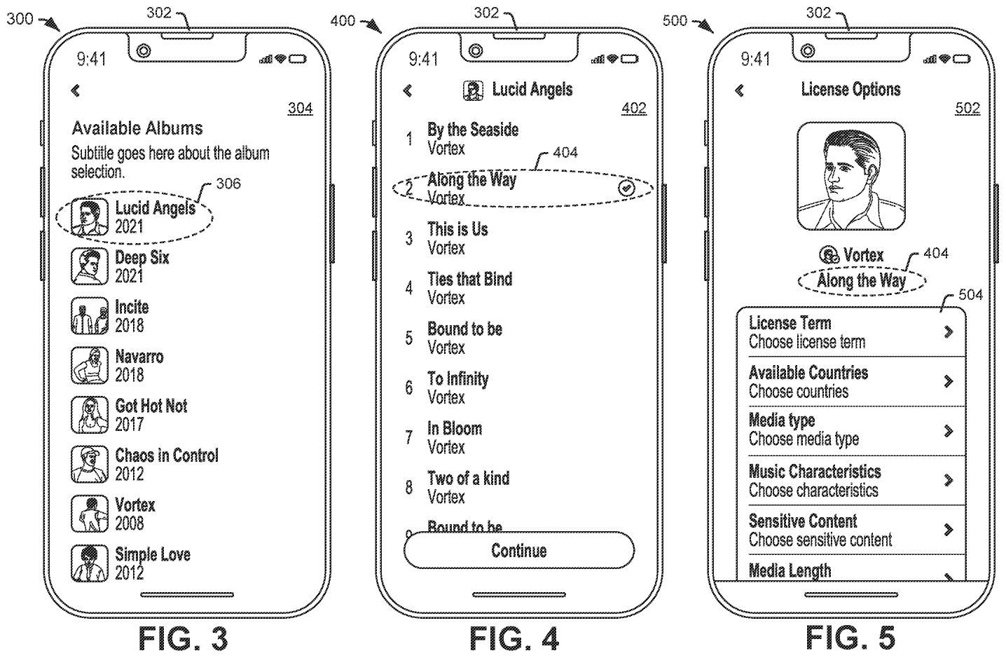

In the context of user interfaces presented to the artist 104 in connection with requesting to enable access to a media content item and selecting one or more terms to control use of the media content item, consider the following discussion of FIGS. 3-13. In one or more implementations, such user interfaces are displayed via appropriately configured display devices that are associated with computing devices, e.g., the display devices are integral with the computing devices or are communicably coupled (via a wired or wireless connection to them). The depicted form factor (mobile phone) should not be considered limiting.

FIG. 3 depicts a non-limiting example 300 of a user interface of an adaptive media content supervision platform.

The illustrated example 300 depicts a computing device 302 displaying a user interface 304 for the artist 104. In this example 300, the user interface 304 surfaces a collection (e.g., a library) of media content items (e.g., a collection of albums) to the artist 104. Collections of media content items may be configured in various ways in accordance with the described techniques, such as by album (e.g., a collection of songs or digital images), by time, by category, or by some other technique (e.g., a clustering technique) that is usable to group media content items into a plurality of groups. In one or more implementations, the user interface allows the artist 104 to select one or more groups of media content items to “drill down” further to view a plurality of individual media content items.

In this example 300, the collection of media content items presented by the user interface 304 includes a plurality of groups of media content items (e.g., a plurality of albums), including individual group 306 of media content items (e.g., an album). In accordance with the described techniques, the individual group 306 may be selectable to display one or more media content items that form the individual group 306.

FIG. 4 depicts a non-limiting example 400 of a user interface of an adaptive media content supervision platform.

The illustrated example 400 depicts the computing device 302 displaying a user interface 402 for the artist 104. In one or more implementations, the user interface 402 is another interface in a series or sequence of user interfaces presented to the artist 104, which enable the artist 104 to select a media content item to make accessible on the media content supervision platform 116 and select one or more terms to control use of the media content item. In this example 400, the user interface 402 presents a plurality of media content items, such as a plurality of media content items (e.g., songs) that are selectable based on user input (e.g., individually or more than one) request that they be made accessible via the media content supervision platform 116. In this example, for instance, the user interface 402 depicts a selected media content item 404. In the context of FIG. 3, the plurality of media content items presented via the user interface 402 may correspond to the media items included in the individual group 306, e.g., a plurality of songs included in the depicted album, “Lucid Angels”. In one or more implementations, the recommendation system 118 may utilize one or more models 120 to analyze media content of the artist 104 in order to recommend one or more media items to make available for licensing and surface this recommendation to the artist 104 via the user interface 402.

FIG. 5 depicts a non-limiting example 500 of a user interface of an adaptive media content supervision platform.

The illustrated example 500 depicts the computing device 302 displaying a user interface 502 for the artist 104. In one or more implementations, the user interface 502 is another interface in a series or sequence of user interfaces presented to the artist 104, which enable the artist 104 to select a media content item to make accessible on the media content supervision platform 116 and select one or more terms to control use of the media content item. In this example 500, the user interface 502 presents a navigation menu 504, which has various term subsets that are selectable for the artist 104 to view and/or specify the terms (e.g., the term(s) 130) for controlling access to the selected media content item 404 and that relate to a subset of the terms. Examples of such subsets include, but are not limited to, license term (e.g., an amount of time for which the selected media content can be licensed), available countries (e.g., countries where a compilation that includes the selected media content item can be distributed), medium of the media item (e.g., a format in which the media content item is provided and/or a format into which the media content item is permitted by the license to be incorporated), digital media characteristics, and media length (e.g., how much of the media content is being made available for licensing by other entities if not the entire media content item), to name just a few. In one or more implementations, the media content supervision platform 116 may present a sequence of the user interfaces, where each user interface corresponds to a different subset of the terms, and the navigation menu 504 may enable the artist 104 to return to the user interface which corresponds to a particular term subset to view and/or modify terms of that subset without repeating the entire sequence of user interfaces.

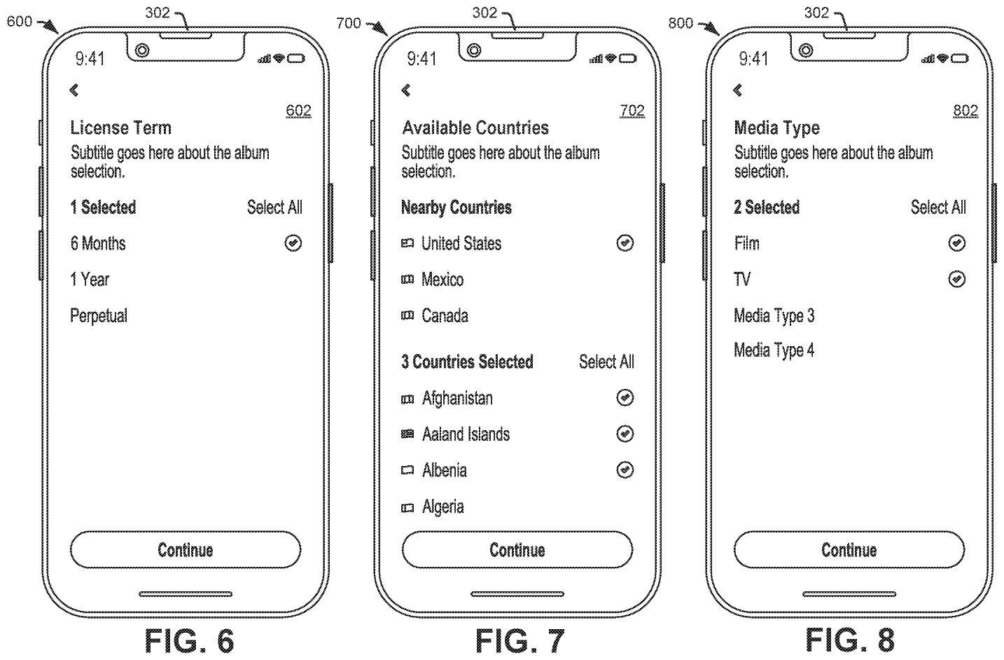

FIG. 6 depicts a non-limiting example 600 of a user interface of an adaptive media content supervision platform.

The illustrated example 600 depicts the computing device 302 displaying a user interface 602 for the artist 104. In one or more implementations, the user interface 602 is another interface in a series or sequence of user interfaces presented to the artist 104, which enable the artist 104 to select a media content item to make accessible on the media content supervision platform 116 and select one or more terms to control use of the media content item. In this example 600, the user interface 602 enables an artist 104 to select one or more of the term(s) 130 for controlling access to the selected media content item. In particular, the user interface 602 enables an artist 104 to select one or more amounts of time (e.g., a license term) for which the selected media content item can be used, e.g., by one of the supervisors 106.

In one or more implementations, the recommendation system 118 may utilize one or more models 120 to analyze the media content item 134 in order to recommend an amount of time for which the supervisor can use the selected media content item. For example, the media content supervision platform 116 may visually distinguish one or more of the amounts of time depicted in the user interface 602 to recommend that the artist 104 select this recommended term. For instance, the models 120 may recommend that an instrumental piece of music have a license granted to the supervisor for 6 months, while an electronic piece of music have a license granted to the supervisor for 12 months, based on past licenses that have yielded better results for the artist.

FIG. 7 depicts a non-limiting example 700 of a user interface of an adaptive media content supervision platform.

The illustrated example 700 depicts the computing device 302 displaying a user interface 702 for the artist 104. In one or more implementations, the user interface 702 is another interface in a series or sequence of user interfaces presented to the artist 104, which enable the artist 104 to select a media content item to make accessible on the media content supervision platform 116 and select one or more terms to control use of the media content item. In this example 700, the user interface 702 enables an artist 104 to select one or more of the term(s) 130 for controlling access to the selected media content item. In particular, the user interface 702 enables the artist 104 to select one or more geographic locations (e.g., countries) in which the selected media content item can be used, e.g., by one of the supervisors 106.

In one or more implementations, the recommendation system 118 may utilize one or more models 120 to analyze the media content item 134 in order to recommend a geographic location in which the selected media content item can be used. For example, the media content supervision platform 116 may visually distinguish one or more of the geographic locations (e.g., Mexico) depicted in the user interface 702 to recommend that the artist 104 select this recommended geographic location.

FIG. 8 depicts a non-limiting example 800 of a user interface of an adaptive media content supervision platform.

The illustrated example 800 depicts the computing device 302 displaying a user interface 802 for the artist 104. In one or more implementations, the user interface 802 is another interface in a series or sequence of user interfaces presented to the artist 104, which enable the artist 104 to select a media content item to make accessible on the media content supervision platform 116 and select one or more terms to control use of the media content item. In this example 800, the user interface 802 enables an artist 104 to select one or more of the term(s) 130 for controlling access to the selected media content item. In particular, the user interface 802 enables the artist 104 to select one or more mediums in which the selected media content item can be incorporated, e.g., a target medium of a compilation being created or otherwise arranged by the supervisor 108.

In one or more implementations, the recommendation system 118 may utilize one or more models 120 to analyze the media content item 134 in order to recommend a medium in which the selected media content item can be used. For example, the media content supervision platform 116 may visually distinguish one or more of the mediums depicted in the user interface 802 (e.g., film or TV) to recommend that the artist 104 select this medium.

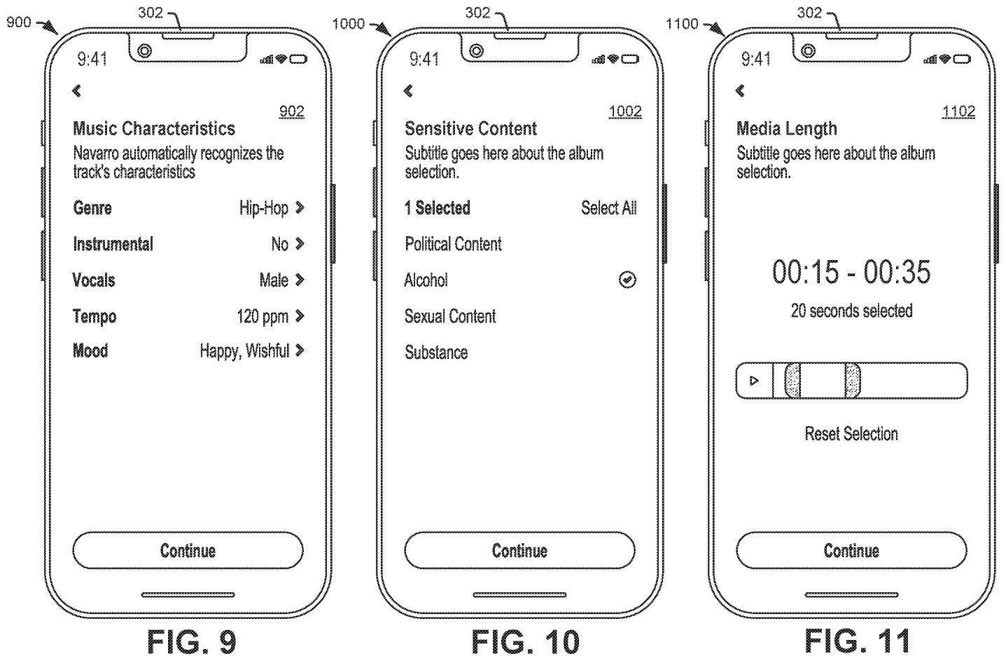

FIG. 9 depicts a non-limiting example 900 of a user interface of an adaptive media content supervision platform.

The illustrated example 900 depicts the computing device 302 displaying a user interface 902 for the artist 104. In one or more implementations, the user interface 902 is another interface in a series or sequence of user interfaces presented to the artist 104, which enable the artist 104 to select a media content item to make accessible on the media content supervision platform 116 and select one or more terms to control use of the media content item. In this example 900, the user interface 902 enables the artist 104 to select one or more characteristics of the selected media content item, such as characteristics that are searchable (e.g., by the supervisors 106) to find the media content item, characteristics that are useable to group the media content item with other similar media content items, and/or characteristics that are useable to distinguish the media content item from other dissimilar media content items. In accordance with the described techniques, the characteristics selected via the user interface 902 include one or more of the characteristic(s) 128 that are made available as options by the media content supervision platform 116 via the user interface 902, and such that the media content supervision platform 116 can associated the selected media content item with selected characteristics once the request 132 is received from the artist 104.

FIG. 10 depicts a non-limiting example 1000 of a user interface of an adaptive media content supervision platform.

The illustrated example 1000 depicts the computing device 302 displaying a user interface 1002 for the artist 104. In one or more implementations, the user interface 1002 is another interface in a series or sequence of user interfaces presented to the artist 104, which enable the artist 104 to select a media content item to make accessible on the media content supervision platform 116 and select one or more terms to control use of the media content item. In this example 1000, the user interface 1002 enables an artist 104 to select one or more of the term(s) 130 for controlling access to the selected media content item. In particular, the user interface 1002 enables the artist 104 to select subject matter of the media content into which the selected media content item is permitted to be incorporated. Alternatively, the user interface 1002 enables the artist 104 to select subject matter of the media content into which the selected media content item is not permitted to be incorporated. In either case, selection of such an option may require the supervisor 108 to specify the subject matter of the compilation into which they intend to incorporate the selected media content item, and the supervisor may be prohibited by the terms of a license from incorporating the selected media content item into a compilation that relates to subject matter that is not permitted based on the selected terms.

In one or more implementations, the recommendation system 118 may utilize one or more models 120 to analyze the media content item 134 in order to recommend subject matter of the media content into which the selected media content item is permitted to be incorporated. For example, the media content supervision platform 116 may visually distinguish one or more of different subject matter types depicted in the user interface 902 (e.g., alcohol) to recommend that the artist 104 select this recommended type of permitted subject matter.

FIG. 11 depicts a non-limiting example 1100 of a user interface of an adaptive media content supervision platform.

The illustrated example 1100 depicts the computing device 302 displaying a user interface 1102 for the artist 104. In one or more implementations, the user interface 1102 is another interface in a series or sequence of user interfaces presented to the artist 104, which enable the artist 104 to select a media content item to make accessible on the media content supervision platform 116 and select one or more terms to control use of the media content item. In this example 1100, the user interface 1102 enables the artist 104 to select which portion of the selected media content item to make available (e.g., to the supervisors 106) on the media content supervision platform 116 for licensing. In one or more implementations, the user interface 1102 enables the artist 104 to select an entirety of the media content item or one or more portions of it (e.g., 20 seconds).

In one or more implementations, the recommendation system 118 may utilize one or more models 120 to analyze the media content item 134 in order to recommend a particular portion of the media content item 134 to make available on the media content supervision platform 116 for licensing. For example, the media content supervision platform 116 may automatically generate and display a representation of the recommended portion of the media content item 134 which should be made available for licensing. In some cases, the models 120 may leverage information received in the series of user interfaces presented to the artist 104 to determine a recommended portion of the media content item 134. For instance, if the artist 104 has selected “Film” as a Media Type in the user interface of example 800, the models 120 may generate a recommendation of a 60-second portion including an introduction of a media content item based on previously licensed media content items for Film. If the artist 104 has selected “Television Advertising” as a Media Type in the user interface of example 800, the models may generate a recommendation of a 30-second portion including a hook of a media content item based on previously licensed media content items for Television Advertising.

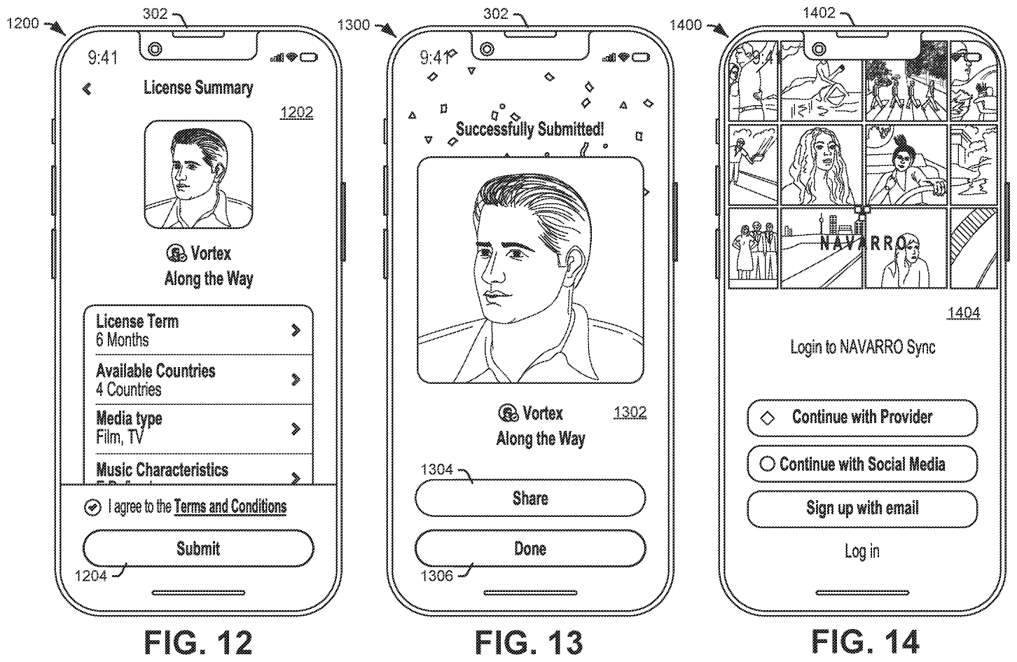

FIG. 12 depicts a non-limiting example 1200 of a user interface of an adaptive media content supervision platform.

The illustrated example 1200 depicts the computing device 302 displaying a user interface 1202 for the artist 104. In one or more implementations, the user interface 1202 is another interface in a series or sequence of user interfaces presented to the artist 104, which enable the artist 104 to select a media content item to make accessible on the media content supervision platform 116 and select one or more terms to control use of the media content item. In this example 1200, the user interface 1202 enables the artist 104 to submit, e.g., based on selection of the interface control 1204, the request 132 to enable access to the selected media content item for licensing (e.g., by the supervisors 106) on the media content supervision platform 116. In one or more implementations, the artist 104 provides an express acceptance of terms and conditions of the media content supervision platform 116 (e.g., based on user input). Alternatively or in addition, the selection of the interface control 1204 impliedly accepts the terms and conditions of the media content supervision platform 116.

FIG. 13 depicts a non-limiting example 1300 of a user interface of an adaptive media content supervision platform.

The illustrated example 1300 depicts the computing device 302 displaying a user interface 1302 for the artist 104. In one or more implementations, the user interface 1302 is another interface in a series or sequence of user interfaces presented to the artist 104, which enable the artist 104 to select a media content item to make accessible on the media content supervision platform 116 and select one or more terms to control use of the media content item. In this example 1300, the user interface 1302 includes a notification that the request 132 was successfully submitted by the artist 104 (and received by the media content supervision platform 116). Additionally, the user interface 1302 enables the artist 104 to select an option 1304 to share that the selected media content item is available on the media content supervision platform 116 for licensing, such as to share via the media content supervision platform 116, a different platform (e.g., a social media platform), email, text message, and so forth. The user interface 1302 is also depicted presenting another option 1306, e.g., a “done” option, to end the media content and term selection process. In one or more implementations, selection of the other option 1306 returns the artist 104 to a particular user interface of the media content supervision platform 116, such as a home screen of the platform or a licensing home screen.

It is to be appreciated that in one or more implementations, one or more of the user interfaces discussed in relation to FIGS. 3-13 may not be presented to the artist 104, e.g., as part of requesting that access to a media content item be enabled and/or selecting terms for controlling access to the media content item. Certainly different user interfaces may be surfaced by the media content supervision platform 116 to the artist 104 to enable the artist 104 to request that access to a media content item be enabled and/or to select terms for controlling access to the media content item.

In the context of user interfaces presented to the supervisor 108 in connection with selecting a media content item and selecting one or more terms with which to license a selected media content item, consider the following discussion of FIGS. 14-28. In one or more implementations, such user interfaces are displayed via appropriately configured display devices that are associated with computing devices, e.g., the display devices are integral with the computing devices or are communicably coupled (via a wired or wireless connection to them). The depicted form factor (mobile phone) should not be considered limiting.

FIG. 14 depicts a non-limiting example 1400 of a user interface of an adaptive media content supervision platform.

The illustrated example 1400 depicts a computing device 1402 displaying a user interface 1404 for the supervisor 108. In this example 1400, the user interface 1404 presents options for the supervisor 108 to log in to an account with the media content supervision platform 116, to access the media content supervision platform 116 using credentials from another service provider system (e.g., a social networking platform), and to create an account with the media content supervision platform 116 (e.g., using an email address). In at least one variation, the supervisor 108 accesses the functionality of the media content supervision platform 116 and/or an application of the platform differently than through the computing device 1402. For instance, the supervisor 108 is presented a home screen of the application automatically after selecting an icon corresponding to the media content supervision platform 116, such as when the supervisor 108 has already logged into the application.

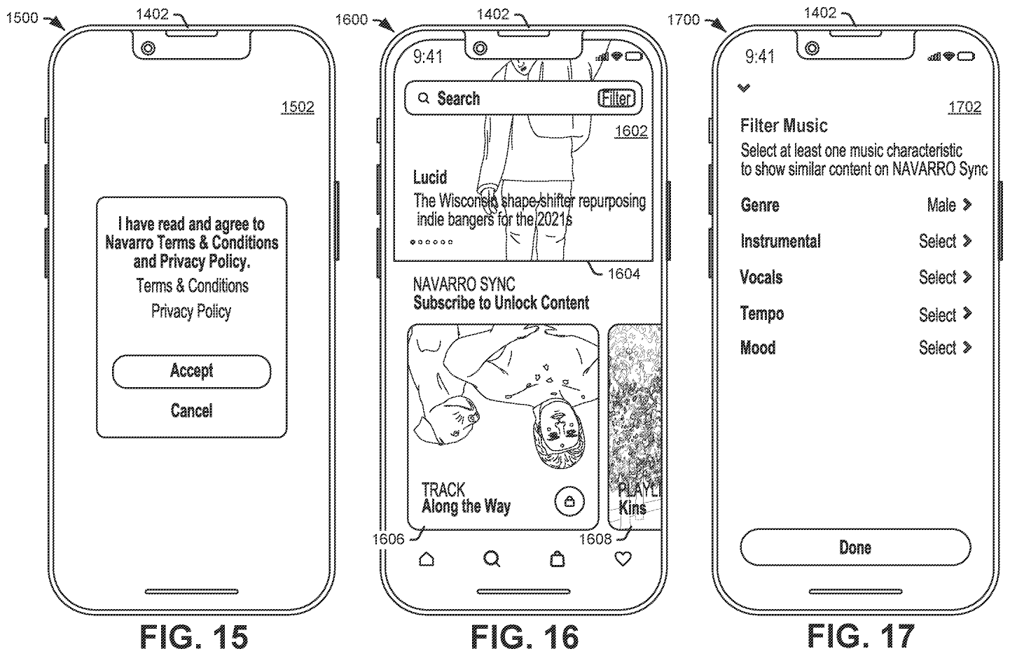

FIG. 15 depicts a non-limiting example 1500 of a user interface of an adaptive media content supervision platform.

The illustrated example 1500 depicts the computing device 1402 displaying a user interface 1502 for the supervisor 108. In this example, the user interface 1502 displays a terms and conditions user-interface element, along with controls (e.g., buttons) to accept the terms and conditions of the media content supervision platform 116 or to cancel. In one or more implementations, the functionality of the media content supervision platform 116 is made available to the supervisor 108 based on acceptance of the terms and conditions and is not made available to the supervisor 108 if acceptance of the terms and conditions is not received (or a portion of the functionality is made available). In this example, the user interface 1502 also includes indications for “Terms & Conditions” and “Privacy Policy.” In at least one variation, one or more of these indications is selectable to present, respectively, the terms and conditions for supervisors to use the media content supervision platform 116 and a privacy policy of the media content supervision platform 116. In one or more implementations, this user interface 1502 is displayed to the supervisor 108 when the supervisor 108 establishes an account with the media content supervision platform 116 or when the media content supervision platform 116 updates one or more of its terms and conditions or privacy policy. When the supervisor 108 accesses the media content supervision platform 116 subsequently (e.g., via an application), this user interface 1502 may not be presented.

FIG. 16 depicts a non-limiting example 1600 of a user interface of an adaptive media content supervision platform.

The illustrated example 1600 depicts the computing device 1402 displaying a user interface 1602 for the supervisor 108. In one or more implementations, the user interface 1602 corresponds to a home screen of an application of the media content supervision platform 116. In this example, the user interface 1602 presents a plurality of recommended media content to the supervisor 108, including an indication of an artist 1604 and indications of media content items 1606, 1608. In one or more implementations, such indications are selectable. For instance the indication of the artist 1604 is selectable to navigate to a user interface associated with the artist and the indications of the media content items 1606, 1608 are selectable to navigate to respective user interfaces associated with the media content items. From such user interfaces, media content items may be selectable for further accepting terms for those media content items and initiating generation of licenses for those items. In one or more implementations, the user interface 1602 presents the recommended media content item(s) 136 to the supervisor 108, e.g., via indications of the media content items. It is to be appreciated that the recommended media content item(s) 136 may be presented to the supervisor 108 in different ways without departing from the spirit or scope of the described techniques.

FIG. 17 depicts a non-limiting example 1700 of a user interface of an adaptive media content supervision platform.

The illustrated example 1700 depicts the computing device 1402 displaying a user interface 1702 for the supervisor 108. In this example, the user interface 1702 enables the supervisor 108 to select desired characteristics of a media content item, such that the selected characteristics are usable by the media content supervision platform 116 to search for and/or recommend media content items to the supervisor 108. By way of example, the user interface 1702 enables the supervisor 108 to select audio characteristics of a song or music that the supervisor 108 would like to license for incorporation into a compilation of media content. Although various characteristics of a song or music are depicted in the illustrated example 1700, it is to be appreciated that different audio characteristics may be selectable without departing from the spirit or scope of the described techniques, and also that characteristics for different types of media content (e.g., digital images) may be presented and selectable in variations without departing from the spirit or scope of the described techniques.

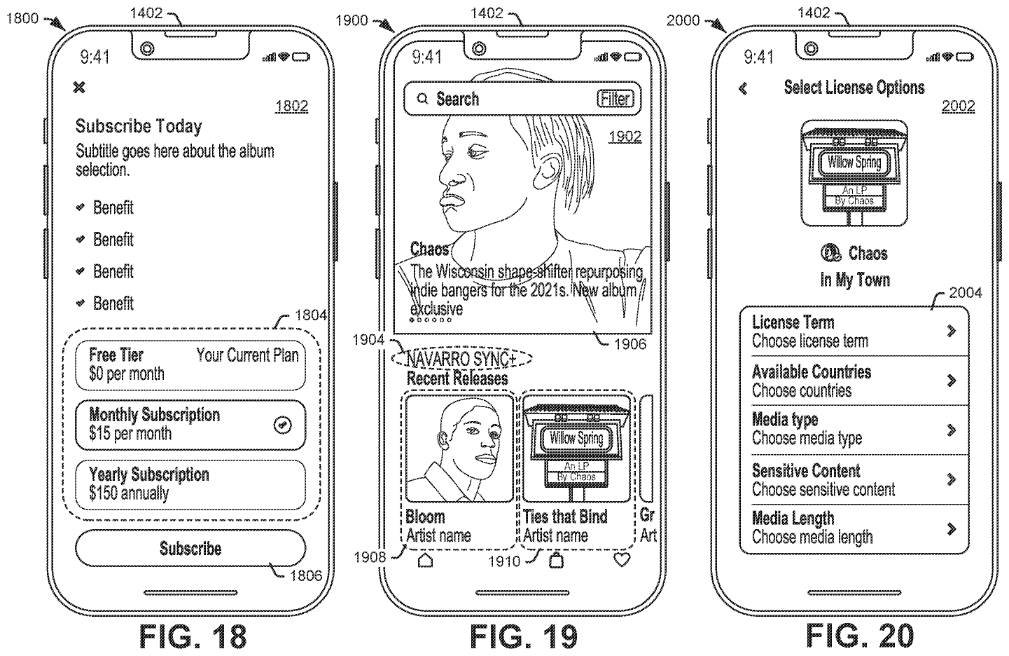

FIG. 18 depicts a non-limiting example 1800 of a user interface of an adaptive media content supervision platform.

The illustrated example 1800 depicts the computing device 1402 displaying a user interface 1802 for the supervisor 108. In this example, the user interface 1802 presents a plurality of subscription options 1804 to the supervisor 108, where the subscription options avail the supervisor 108 to different levels of functionality of the media content supervision platform 116. For instance, in at least one example, a first of the subscription options 1804 permits the supervisor 108 to access a limited subset of functionality of the media content supervision platform 116 and a second of the subscription options 1804 permits the supervisor 108 to access more of the functionality (e.g., all or a larger subset of the functionality) or improved functionality relative to the first option. In this example 1800, the user interface 1802 also includes an interface control 1806 to initiate access to the media content supervision platform 116 in accordance with a selected subscription option 1804.

FIG. 19 depicts a non-limiting example 1900 of a user interface of an adaptive media content supervision platform.

The illustrated example 1900 depicts the computing device 1402 displaying a user interface 1902 for the supervisor 108. In one or more implementations, the user interface 1902 corresponds to another home screen of an application of the media content supervision platform 116. In contrast to the user interface depicted in the example 1600, though, the user interface 1902 includes an indication 1904 of an upgraded subscription for the supervisor 108 with the media content supervision platform 116.

The user interface 1902 also presents a plurality of recommended media content to the supervisor 108, including an indication of an artist 1906 and indications of media content items 1908, 1910. As noted above, such indications may be selectable. For instance the indication of the artist 1906 may be selectable to navigate to a user interface associated with the artist and the indications of the media content items 1908, 1910 may be selectable to navigate to respective user interfaces associated with the media content items. From such user interfaces, media content items may be selectable for further accepting terms for those media content items and initiating generation of licenses for those items. In one or more implementations, the user interface 1902 may present the recommended media content item(s) 136 to the supervisor 108, e.g., via indications of the media content items.

FIG. 20 depicts a non-limiting example 2000 of a user interface of an adaptive media content supervision platform.

The illustrated example 2000 depicts the computing device 1402 displaying a user interface 2002 for the supervisor 108. In one or more implementations, the user interface 2002 is an interface in a series or sequence of user interfaces presented to the supervisor 108, which enable the supervisor 108 to select a media content item to license and/or to provide control signals which define the terms which controls the supervisor 108's use of a selected media content item. In this example 2000, the user interface 2002 presents a navigation menu 2004, which has various term subsets that are selectable for the supervisor 108 to view and/or provide control signals for defining various terms (e.g., the term(s) 130) that control access to a selected media content item and that relate to a subset of the terms. Examples of the subsets in relation to which the supervisor 108 may provide control signals include, but are not limited to, license duration (e.g., an amount of time for which the selected media content can be licensed), available countries (e.g., countries to which the supervisor 108 agrees to limit distribution of a compilation including the selected media item), media type (e.g., a format in which the media content item is obtained by the supervisor 108 and/or a format into which the media content item is permitted to be incorporated by a license), content related limitations and/or prohibitions, and media length (e.g., how much of the media content is desired for licensing), to name just a few. In one or more implementations, the media content supervision platform 116 may present a sequence of the user interfaces, where each user interface requests control signals for defining different subsets of terms, and the navigation menu 2004 may enable the supervisor 108 to return to the user interface which corresponds to a particular term subset to view and/or provide control signals to define different terms of that subset without repeating the entire sequence of user interfaces.

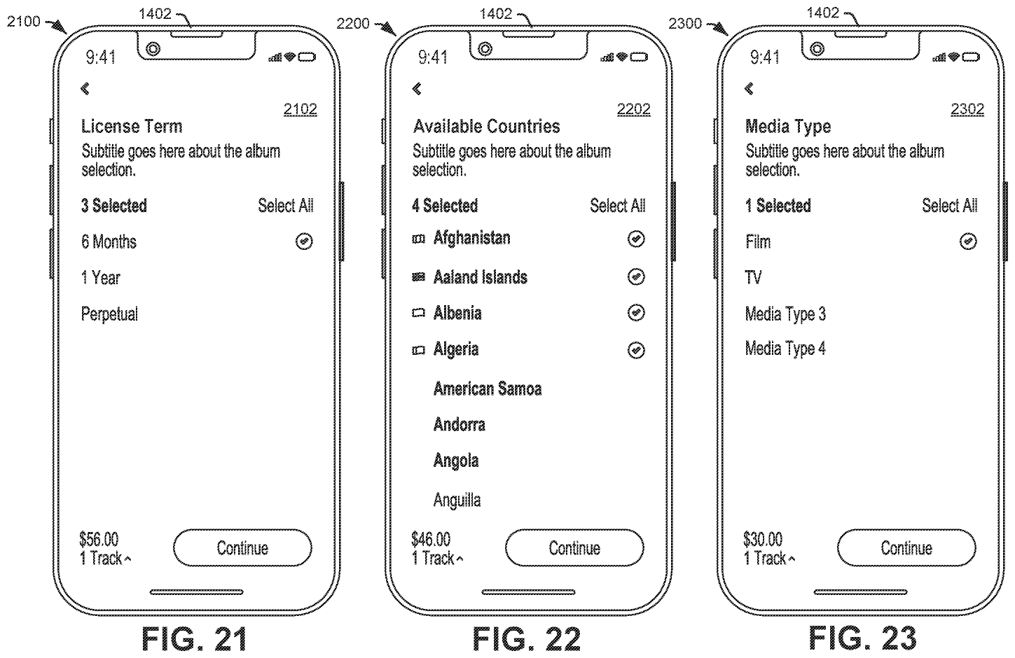

FIG. 21 depicts a non-limiting example 2100 of a user interface of an adaptive media content supervision platform.

The illustrated example 2100 depicts the computing device 1402 displaying a user interface 2102 for the supervisor 108. In one or more implementations, the user interface 2102 is an interface in a series or sequence of user interfaces presented to the supervisor 108, which enable the supervisor 108 to select a media content item to license and/or select terms with which to license a selected media content item. In this example 2100, the user interface 2102 enables the supervisor 108 to provide a selection to accept one or more of the term(s) 130 that control access to a selected media content item. In particular, the user interface 2102 enables the supervisor 108 to select one or more amounts of time (e.g., a license term) for which the supervisor 108 desires to license the selected media content item, e.g., for use by the supervisor 108 in a compilation of media content.

FIG. 22 depicts a non-limiting example 2200 of a user interface of an adaptive media content supervision platform.

The illustrated example 2200 depicts the computing device 1402 displaying a user interface 2202 for the supervisor 108. In one or more implementations, the user interface 2202 is an interface in a series or sequence of user interfaces presented to the supervisor 108, which enable the supervisor 108 to select a media content item to license and/or select terms with which to license a selected media content item. In this example 2200, the user interface 2202 enables the supervisor 108 to provide a selection to accept one or more of the term(s) 130 that control access to a selected media content item. In particular, the user interface 2202 enables the supervisor 108 to select one or more geographic locations (e.g., countries) where the supervisor 108 desires to license the selected media content item, e.g., so that the supervisor 108 is licensed to distribute a compilation that incorporates the selected media content item in the selected geographic locations.

FIG. 23 depicts a non-limiting example 2300 of a user interface of an adaptive media content supervision platform.

The illustrated example 2300 depicts the computing device 1402 displaying a user interface 2302 for the supervisor 108. In one or more implementations, the user interface 2302 is an interface in a series or sequence of user interfaces presented to the supervisor 108, which enable the supervisor 108 to select a media content item to license and/or select terms with which to license a selected media content item. In this example 2300, the user interface 2302 enables the supervisor 108 to provide a selection to accept one or more of the term(s) 130 that control access to a selected media content item. In particular, the user interface 2302 enables the supervisor 108 to select one or more types of media content into which the supervisor 108 agrees to incorporate the selected media content item, e.g., a target media content type of a compilation being created or otherwise arranged by the supervisor 108.

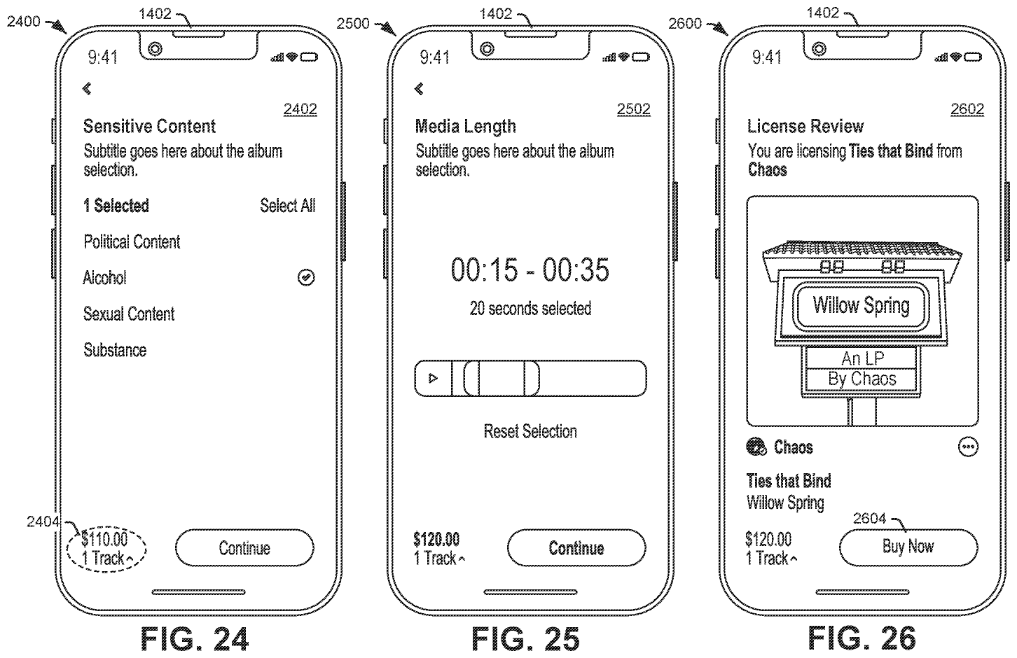

FIG. 24 depicts a non-limiting example 2400 of a user interface of an adaptive media content supervision platform.

The illustrated example 2400 depicts the computing device 1402 displaying a user interface 2402 for the supervisor 108. In one or more implementations, the user interface 2402 is an interface in a series or sequence of user interfaces presented to the supervisor 108, which enable the supervisor 108 to select a media content item to license and/or select terms with which to license a selected media content item. In this example 2400, the user interface 2402 enables the supervisor 108 to provide a selection to accept one or more of the term(s) 130 that control access to a selected media content item. In particular, the user interface 2402 enables the supervisor 108 to select subject matter to which a compilation of media content that incorporates the selected media content item can relate. For instance, if a subject matter option is selected, the license eventually generated by the media content supervision platform 116 permits the supervisor 108 to incorporate the selected media content item into a compilation that relates to the selected subject matter. Whereas, if a subject matter option is not selected, the license may not permit the supervisor 108 to incorporate the selected media content item into a compilation that relates to the selected subject matter. In one or more implementations, selection of a subject matter option corresponds to an increase in a cost 2404 to license the selected subject matter.

FIG. 25 depicts a non-limiting example 2500 of a user interface of an adaptive media content supervision platform.

The illustrated example 2500 depicts the computing device 1402 displaying a user interface 2502 for the supervisor 108. In one or more implementations, the user interface 2502 is an interface in a series or sequence of user interfaces presented to the supervisor 108, which enable the supervisor 108 to select a media content item to license and/or select terms with which to license a selected media content item. In this example 2500, the user interface 2502 enables the supervisor 108 to select which portion of the selected media content item to obtain for licensing, e.g., from a portion of the media content item that has been made available for licensing by the artist 104. In one or more implementations, the user interface 1102 enables the supervisor 108 to select an entirety of the media content item or one or more portions of it, e.g., 20 seconds.

FIG. 26 depicts a non-limiting example 2600 of a user interface of an adaptive media content supervision platform.

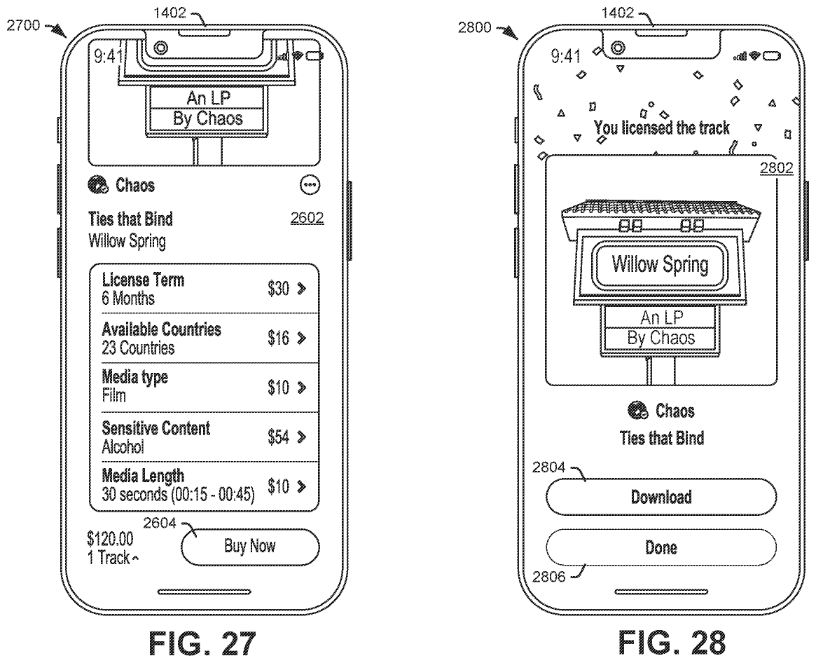

The illustrated example 2600 depicts the computing device 1402 displaying a user interface 2602 for the supervisor 108. In one or more implementations, the user interface 2602 is an interface in a series or sequence of user interfaces presented to the supervisor 108, which enable the supervisor 108 to select a media content item to license and/or select terms with which to license a selected media content item. In this example 2600, the user interface 2602 enables to review a selected media content item as well as the terms the supervisor 108 selected for licensing the selected media content item. In one or more implementations, the user interface 2602 is scrollable (as depicted in FIG. 27) to review more information which corresponds to the license (e.g., selected terms) than is depicted in the illustrated example 2600. In this example 2600, the user interface also includes a control 2604 (e.g., a button) to select the indicated media content and accept the terms. In one or more implementations, responsive to selecting the control 2604, for instance, the supervisor 108 provides and the media content supervision platform 116 receives the selection 138 of the media content item 134 and the term acceptance 140. In one or more implementations, the selection 138 and the term acceptance 140 are generated (e.g., by an application) based on receiving input from the supervisor 108 via one or more user interfaces of a series of user interfaces, such as a series of user interface described above in relation to FIGS. 14-25.

FIG. 27 depicts a non-limiting example 2700 of a user interface of an adaptive media content supervision platform.

The illustrated example 2700 depicts the computing device 1402 displaying the user interface 2602 for the supervisor 108. In this example, however, the user interface 2602 has been scrolled down (e.g., based on user input from the supervisor 108) to view more information which corresponds to licensing the indicated media content item. Like FIG. 26, the illustrated example 2700 also includes the control 2604, which persists in the scrolled down view of the user interface 2602 and is selectable via user input to select the indicated media content and accept the terms.

FIG. 28 depicts a non-limiting example 2800 of a user interface of an adaptive media content supervision platform.

The illustrated example 2800 depicts the computing device 1402 displaying a user interface 2802 for the supervisor 108. In one or more implementations, the user interface 2802 is an interface in a series or sequence of user interfaces presented to the supervisor 108, which enable the supervisor 108 to select a media content item to license and/or select terms with which to license a selected media content item. In this example 2800, the user interface 2802 includes a notification that the supervisor 108 successfully licensed the media content item 134. In one or more implementations, this indicates that media content supervision platform 116 has generated and the supervisor 108 has received or has otherwise been granted the license 142 to use the media content item 134 in accordance with the term(s) 130 included in the license. In this example, the user interface 2802 also provides access to the licensed media content item, e.g., the media content item 134. By way of example, the user interface 2802 includes an interface control 2804, which is selectable to obtain the media content item 134. In this example, the interface control 2804 is selectable to download the media content item 134, e.g., to a computing device of the supervisor 108. It is to be appreciated that the media content supervision platform 116 may provide and the supervisor 108 may obtain access to a licensed media content item in other ways without departing from the spirit or scope of the described techniques. The user interface 2802 is also depicted presenting another option 2806, e.g., a “done” option, to end the media content selection and term acceptance process. In one or more implementations, selection of the other option 2806 returns the supervisor 108 to a particular user interface of the media content supervision platform 116, such as a home screen of the platform or a licensing home screen.

It is to be appreciated that in one or more implementations, one or more of the user interfaces discussed in relation to FIGS. 14-28 may not be presented to the supervisor 108, e.g., as part of selecting a media content item to license and/or selecting terms with which to license a selected media content item. Certainly different user interfaces may be surfaced by the media content supervision platform 116 to the supervisor 108 to enable the artist 104 to select a media content item and/or to select the terms with which license to the media content item.

The following discussion describes examples of procedures for an adaptive media content supervision platform. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

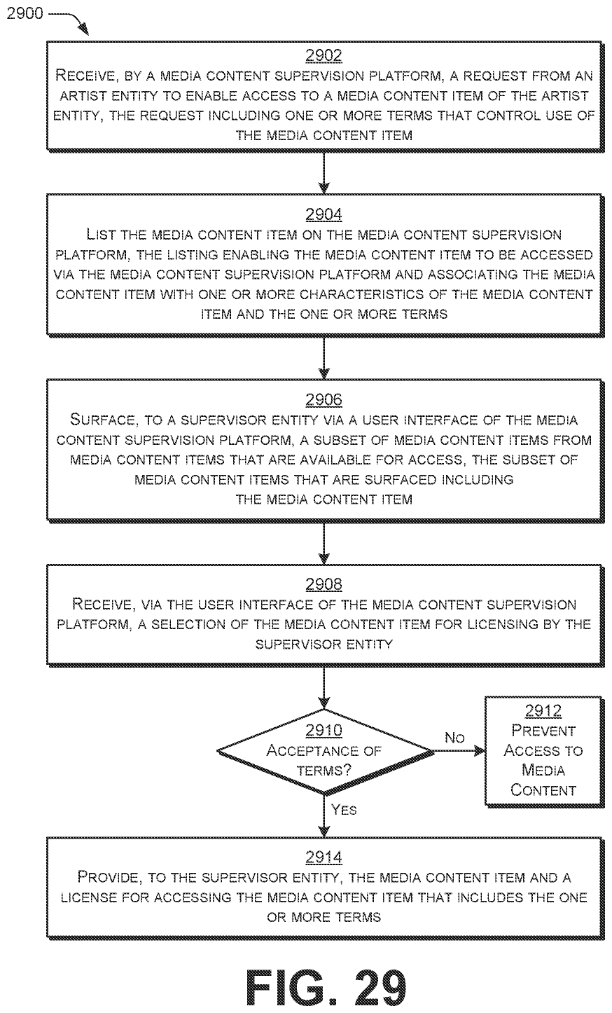

FIG. 29 depicts a procedure 2900 in an example implementation of an adaptive media content supervision platform.

A request is received from an artist entity, by a media content supervision platform, to enable access to a media content item of the artist entity (block 2902). In accordance with the principles discussed herein, the request includes one or more terms that control use of the media content item. By way of example, an artist 104 provides a request 132 to the media content supervision platform 116 to enable access to a media content item 134 of the artist 104. The request 132 includes term(s) 130, which control use of the media content item, e.g., by the supervisors 106. By way of example, the request 132 may be generated responsive to receiving user input from the artist 104 via a sequence of user interfaces, which guide the artist 104 through a workflow of selecting the media content item 134 (which may correspond to a portion of a media content item in one or more implementations) and defining the term(s) 130 based on selections of one or more user interface controls, as discussed in more detail above.

In some embodiments, platform 116 includes options to identify media content item to synchronize with another media content item or compilation. A supervisor interface can set a time stamp for various cues and then specify the kind of media content item (e.g., with specific terms and/or characteristics) to play at those time stamps. The supervisor interface can also preview a media compilation with the suggested media content item 136. For example, the platform 116 may specify for a particular video that time stamp 1:20-2:40 are designated as a cue where music is to be inserted. In some embodiments, the supervisor interface can capture a time stamp for a specific media compilation and then export that time to the artist interface (with specifications of characteristics of the media compilation) to find matching artist media content item.

The media content item is listed on the media content supervision platform (block 2904). In accordance with the principles discussed herein, the listing enables the media content item to be accessed via the media content supervision platform and associates the media content item with one or more characteristics of the media content item and the one or more terms. By way of example, the media content supervision platform 116 receives the request 132 from the artist 104, and the media content supervision platform 116 enables access to the media content item 134 by listing the media content item 134 on the media content supervision platform 116, such that the media content item 134 is surfaced to client devices of users of the media content supervision platform 116, e.g., users with sufficient permission(s). For example, the media content supervision platform 116 generates a listing of the media content item 134, which is listed on the media content supervision platform 116 with listings for a plurality of other media items, e.g., other media items of the artist 104 and/or other artists. As part of the listing, the media content supervision platform 116 associates the media content item 134 with one or more of the characteristic(s) 128. Additionally, the media content supervision platform 116 associates the media content item 134 with the term(s) 130, which may include one or more terms in various scenarios. Broadly, the term(s) 130 control use of the media content item 134, such as by an entity (e.g., a supervisor 108) that acquires the media content item 134 for use, e.g., the term(s) 130 are included as part of and/or define a license for use of the media content item 134 by the supervisor 108.

A subset of media content items from media content items that are available for access are surfaced to a supervisor entity via a user interface of the media content supervision platform (block 2906). In accordance with the principles discussed herein, the subset of media content items that are surfaced include the media content item. By way of example, the media content supervision platform 116 surfaces one or more media content items to the supervisors 106. For example, the media content supervision platform 116 surfaces listings to the supervisors 106 via an interface of the media content supervision platform 116, where the listings each list a respective media content item made accessible on the media content supervision platform 116 by a respective artist entity (or by an entity associated with the artist entity). The media content supervision platform 116 may surface recommended media content item(s) 136 (which may be referred to in one or more figures as recommended M.C. item(s) 136) to the supervisor 108. The recommended media content item(s) 136 include the media content item 134 from the artist 104. The recommended media content item(s) 136 may be surfaced to the supervisor 108, for instance, via a user interface of the media content supervision platform 116 and responsive to various actions of the supervisor 108 with the media content supervision platform 116, such as one or more of the actions described above, e.g., opening an application, requesting a recommendation of media content items, searching for media content items, and so on.

A selection of the media content item for licensing by the supervisor entity is received via the user interface of the media content supervision platform (block 2908). By way of example, the supervisor 108 provides a selection 138 of the media content item 134 via a user interface.

At block 2910, a determination is made as to whether the supervisor entity has agreed to the terms that control access to the media content item. By way of example, the selection 138 of the media content item 134 via the user interface may include a term acceptance 140, which accepts the term(s) 130 associated with the media content item 134 that the artist 104 indicated are acceptable for use of the media content item 134. If the selection at block 2908 does not include a term acceptance that accepts the terms associated with the media content item, then the media content supervision platform prevents access to the media content item by the supervisor entity (block 2912).

If, however, the selection at block 2908 accepts the terms associated with the media content item, then the media content item and a license for accessing the media content item that includes the one or more terms is provided to the supervisor entity (block 2914). By way of example, if it is determined that the supervisor 108 has accepted the terms 130 associated with the media content item 134, then the media content supervision platform 116 generates a license 142 for the media content item 134 which includes the term(s) 130. In particular, the license 142 is generated by the media content supervision platform 116 to permit the supervisor 108 (or an entity corresponding to the supervisor) to use the media content item 134 according to the term(s) 130 of the license 142. The media content supervision platform 116 provides the license 142 to the supervisor 108. For example, the media content supervision platform 116 communicates a document and/or some other digital mechanism (e.g., a smart contract) corresponding to the license 142 to the supervisor 108. Alternatively or additionally, the media content supervision platform 116 presents the license 142 (and/or terms of the license) to the supervisor 108 via a user interface. Thus, the supervisor 108 receives access to the media content item 134 of the artist 104 (e.g., for use in a compilation of media content items) from the media content supervision platform 116, along with the license 142 which meets the term(s) 130 specified by the artist 104 for using the media content item 134. Alternatively, the media content item and the license are not provided to the supervisor 108 if the sup

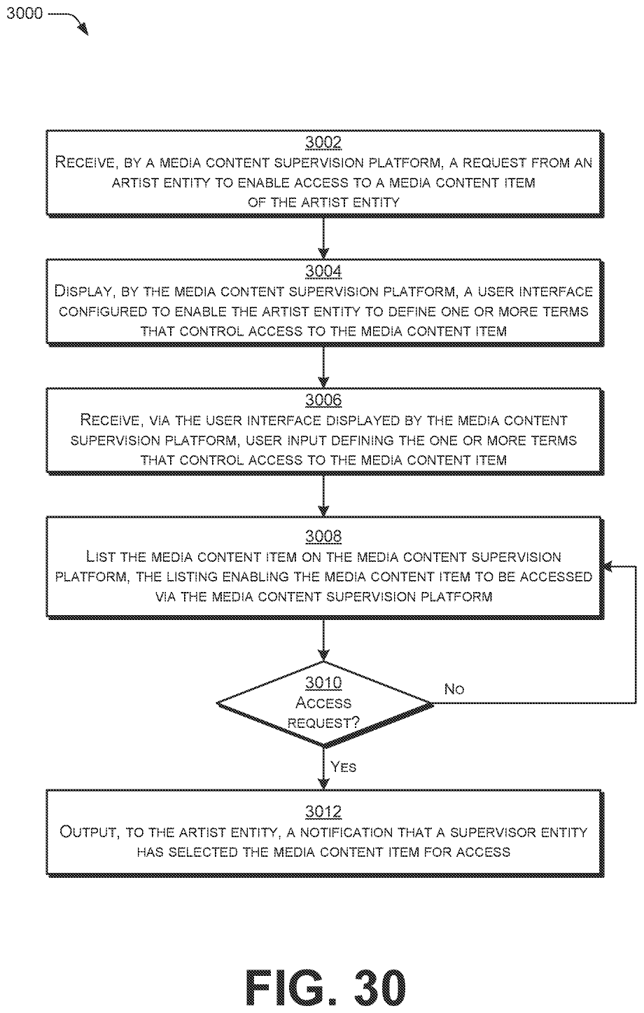

FIG. 30 depicts a procedure 3000 in an example implementation of an adaptive media content supervision platform.

A request is received from an artist entity, by a media content supervision platform, to enable access to a media content item of the artist entity (block 3002). By way of example, an artist 104 provides a request 132 to the media content supervision platform 116 to enable access to a media content item 134 of the artist 104.

A user interface configured to enable the artist entity to define one or more terms that control access to the media content item is displayed by the media content supervision platform (block 3004). By way of example, a user interface configured to enable the artist entity to define one or more terms that control access to the media content item 134 is displayed by the media content supervision platform 116. In one or more implementations, the media content supervision platform may display a sequence of user interfaces to guide the artist 104 through a workflow of selecting the media content item 134 and defining the terms 130 based on selections of one or more user interface controls. An example of displaying a sequence of user interfaces for the artist 104 is discussed above with regards to FIGS. 3-13. It is to be appreciated that in one or more implementations, one or more of the user interfaces discussed in relation to FIGS. 3-13 may not be presented to the artist 104, e.g., as part of requesting that access to a media content item be enabled and/or selecting terms for controlling access to the media content item. Certainly different user interfaces may be surfaced by the media content supervision platform 116 to the artist 104 to enable the artist 104 to request that access to a media content item be enabled and/or to select terms for controlling access to the media content item.

User input defining the one or more terms that control access to the media content item is received via the user interface displayed by the media content supervision platform (block 3006). By way of example, user input defining the one or more terms 130 that control access to the media content item 134 is received via a user interface displayed by the media content supervision platform 116, e.g. via one or more of the user interfaces depicted in FIGS. 3-13 discussed above.

The media content item is listed on the media content supervision platform (block 3008). In accordance with the principles discussed herein, the listing enables the media content item to be accessed via the media content supervision platform (block 3008). By way of example, the media content supervision platform 116 enables access to the media content item 134 by listing the media content item 134 on the media content supervision platform 116, such that the media content item 134 is surfaced to client devices of users of the media content supervision platform 116, e.g., users with sufficient permission(s). For example, the media content supervision platform 116 generates a listing of the media content item 134, which is listed on the media content supervision platform 116 with listings for a plurality of other media items, e.g., other media items of the artist 104 and/or other artists.

At block 3010, a determination is made as to whether an access request to access the media content item listed on the media content supervision platform has been received from a supervisor entity. By way of example, the media content supervision platform 116 monitors requests received from supervisors 108 to access the media content item 134. A supervisor 108 can access the media content item 134, for example, by providing a selection 138 of the media content item 134 which includes a term acceptance 140 accepting the term(s) 130 associated with the media content item 134. If an access request to access the media content item is not received, then the media content supervision platform 116 continues to wait for a supervisor 108 to request the media content item 134 for access.

When an access request to access the media content item is received, then a notification that a supervisor entity has selected the media content item for access is output to the artist entity (block 3012). By way of example, if a supervisor 108 selects the media content item 134 for access, then the media content supervision platform 116 provides the license notification 144 to the artist 104. The license notification 144 indicates that the media content item 134 has been licensed, e.g., to the supervisor. In at least one variation, the media content supervision platform 116 provides a dashboard (e.g., via a user interface) to the artist 104, which provides a status of one or more of the artist 104's media content items (e.g., in terms of licensing). By way of example, the media content supervision platform 116 provides a dashboard that lists the media content items which the artist has requested to list on the media content supervision platform 116, e.g., as being available for one or more supervisors 106 to use in compilations. In one or more implementations, the dashboard may also indicate media content items of the artist 104 which are electronically visible (e.g., known) to the media content supervision platform 116 but are not listed for use.

FIG. 31 illustrates an example environment 3100. The environment 3100 includes server(s) 3102 that can communicate over a network 3104 with user devices 3106 (which, in some examples can be merchant devices 3108 (individually, 3108(A)-3108(N))) and/or server(s) 3110 associated with third-party service provider(s). The server(s) 3102 can be associated with a service provider that can provide one or more services for the benefit of users 3114, as described below. Actions attributed to the service provider can be performed by the server(s) 3102.

In the context of the previously described figures, for example, at least a portion of the server(s) 3102 may be used to implement the media content supervision platform 116 and/or various portions of the media content service provider system 102.

The environment 3100 can include a plurality of user devices 3106, as described above. Each one of the plurality of user devices 3106 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IOT) device, etc. In some examples, individual ones of the user devices can be operable by users 3114. The users 3114 can be referred to as customers, buyers, merchants, sellers, borrowers, employees, employers, payors, payees, couriers and so on. The users 3114 can interact with the user devices 3106 via user interfaces presented via the user devices 3106, such as one or more of the user interfaces depicted in FIGS. 3-28. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 3106 can have an instance or versioned instance of an application, which can be downloaded from an application store, for example, which can present the user interface(s) described herein. In at least one example, a user 3114 can interact with the user interface via touch input, spoken input, or any other type of input.

As described above, in at least one example, the users 3114 can include merchants 3116 (individually, 3116(A)-3116(N)). In an example, the merchants 3116 can operate respective merchant devices 3108, which can be user devices 3106 configured for use by merchants 3116. By way of example, a merchant device 3108 may be configured with a user interface that enables a respective merchant to accept cryptocurrency payments from a user device 3106 of a customer. For the purpose of this discussion, a “merchant” can be any entity that offers items (e.g., goods or services) for purchase or other means of acquisition (e.g., rent, borrow, barter, etc.). The merchants 3116 can offer items for purchase or other means of acquisition via brick-and-mortar stores, mobile stores (e.g., pop-up shops, food trucks, etc.), online stores, combinations of the foregoing, and so forth. In some examples, at least some of the merchants 3116 can be associated with a same entity but can have different merchant locations and/or can have franchise/franchisee relationships. In additional or alternative examples, the merchants 3116 can be different merchants. That is, in at least one example, the merchant 3116(A) is a different merchant than the merchant 3116(B) and/or the merchant 3116(C).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

Each merchant device 3108 can have an instance of a POS application 3118 stored thereon. The POS application 3118 can configure the merchant device 3108 as a POS terminal, which enables the merchant 3116(A) to interact with one or more customers 3120. As described above, the users 3114 can include customers, such as the customers 3120 shown as interacting with the merchant 3116(A). For the purpose of this discussion, a “customer” can be any entity that acquires items from merchants. While two customers 3120 are illustrated in FIG. 31, any number of customers 3120 can interact with the merchants 3116. Further, while FIG. 31 illustrates the customers 3120 interacting with the merchant 3116(A), the customers 3120 can interact with any of the merchants 3116.

In at least one example, interactions between the customers 3120 and the merchants 3116 that involve the exchange of funds (from the customers 3120) for items (from the merchants 3116) can be referred to as “transactions.” In at least one example, the POS application 3118 can determine transaction data associated with the POS transactions. Transaction data can include payment information, which can be obtained from a reader device 3122 associated with the merchant device 3108(A), user authentication data, purchase amount information, point-of-purchase information (e.g., item(s) purchased, date of purchase, time of purchase, etc.), etc. The POS application 3118 can send transaction data to the server(s) 3102 such that the server(s) 3102 can track transactions of the customers 3120, merchants 3116, and/or any of the users 3114 over time. Furthermore, the POS application 3118 can present a user interface to enable the merchant 3116(A) to interact with the POS application 3118 and/or the service provider via the POS application 3118.

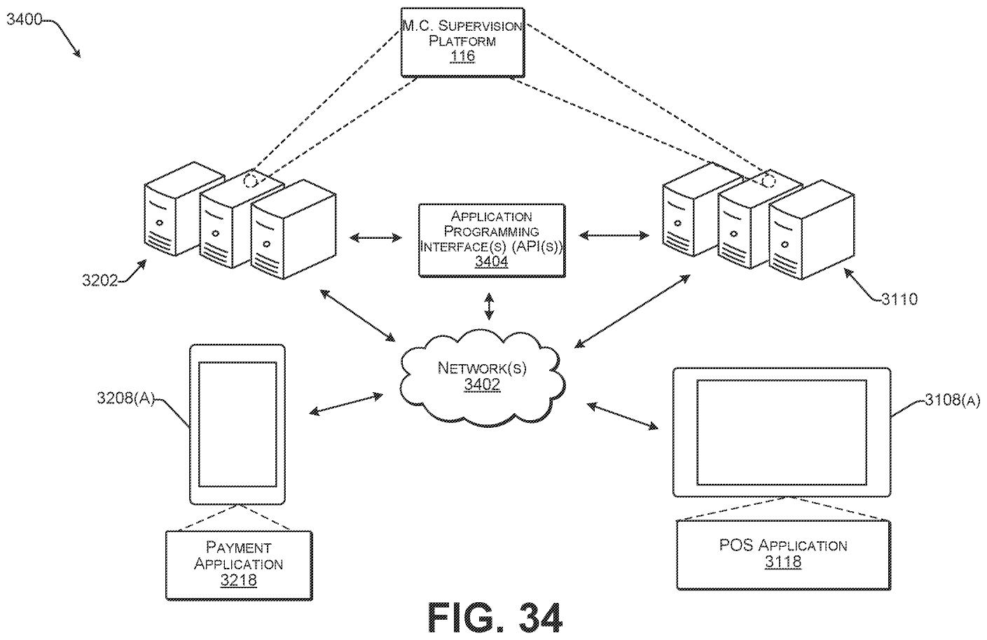

In at least one example, the merchant device 3108(A) can be a special-purpose computing device configured as a POS terminal (via the execution of the POS application 3118). In at least one example, the POS terminal may be connected to a reader device 3122, which is capable of accepting a variety of payment instruments, such as credit cards, debit cards, gift cards, short-range communication-based payment instruments, and the like, as described below. In at least one example, the reader device 3122 can plug in to a port in the merchant device 3108(A), such as a microphone port, a headphone port, an audio-jack, a data port, or other suitable port. In additional or alternative examples, the reader device 3122 can be coupled to the merchant device 3108(A) via another wired or wireless connection, such as via a Bluetooth®, BLE, and so on. Additional details are described below with reference to FIG. 34. In some examples, the reader device 3122 can read information from alternative payment instruments including, but not limited to, wristbands and the like.

In some examples, the reader device 3122 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 3122, and communicate with the server(s) 3102, which can provide, among other services, a payment processing service. The server(s) 3102 associated with the service provider can communicate with server(s) 3110, as described below. In this manner, the POS terminal and reader device 3122 may collectively process transaction(s) between the merchants 3116 and customers 3120. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 3122 of the POS system 3124 are shown as separate devices, in additional or alternative examples, the POS terminal and the reader device 3122 can be part of a single device. In some examples, the reader device 3122 can have a display integrated therein for presenting information to the customers 3120. In additional or alternative examples, the POS terminal can have a display integrated therein for presenting information to the customers 3120. POS systems, such as the POS system 3124, may be mobile, such that POS terminals and reader devices may process transactions in disparate locations across the world. POS systems can be used for processing card-present transactions and card-not-present (CNP) transactions, as described below.

A card-present transaction is a transaction where both a customer 3120 and his or her payment instrument are physically present at the time of the transaction. Card-present transactions may be processed by swipes, dips, taps, or any other interaction between a physical payment instrument (e.g., a card), or otherwise present payment instrument, and a reader device 3122 whereby the reader device 3122 is able to obtain payment data from the payment instrument. A swipe is a card-present transaction where a customer 3120 slides a card, or other payment instrument, having a magnetic strip through a reader device 3122 that captures payment data contained in the magnetic strip. A dip is a card-present transaction where a customer 3120 inserts a payment instrument having an embedded microchip (i.e., chip) into a reader device 3122 first. The dipped payment instrument remains in the payment reader until the reader device 3122 prompts the customer 3120 to remove the card, or other payment instrument. While the payment instrument is in the reader device 3122, the microchip can create a one-time code which is sent from the POS system 3124 to the server(s) 3110 (which can be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 3120 may tap or hover his or her payment instrument (e.g., card, electronic device such as a smart phone running a payment application, etc.) over a reader device 3122 to complete a transaction via short-range communication (e.g., NFC, RFID, Bluetooth®, BLE, etc.). Short-range communication enables the payment instrument to exchange information with the reader device 3122. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 3124, the server(s) 3102, and/or the server(s) 3110 may exchange payment information and transaction data to determine whether transactions are authorized. For example, the POS system 3124 may provide encrypted payment data, user authentication data, purchase amount information, point-of-purchase information, etc. (collectively, transaction data) to server(s) 3102 over the network(s) 3104. The server(s) 3102 may send the transaction data to the server(s) 3110. As described above, in at least one example, the server(s) 3110 can be associated with third-party service providers that provide payment services, including but not limited to, an acquirer bank, an issuer, a cryptocurrency exchange network, and/or a card payment network (e.g., Mastercard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server(s) 3110 associated therewith) can send a fund transfer request to a server computing device of a card payment network (e.g., Mastercard®, VISA®, etc.) to determine whether the transaction is authorized or deficient. In at least one example, the service provider can serve as an acquirer and connect directly with the card payment network.

The card payment network (e.g., the server(s) 3110 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server(s) 3110 associated therewith) can make a determination as to whether the customer has the capacity to absorb the relevant charge associated with the payment transaction. In at least one example, the service provider can serve as an issuer and/or can partner with an issuer. The transaction is either approved or rejected by the issuer and/or the card payment network (e.g., the server(s) 3110 associated therewith), and a payment authorization message is communicated from the issuer to the POS device via a path opposite of that described above, or via an alternate path.

As described above, the server(s) 3110, which can be associated with payment service provider(s), may determine whether the transaction is authorized based on the transaction data, as well as information relating to parties to the transaction (e.g., the customer 3120 and/or the merchant 3116(A)). The server(s) 3110 may send an authorization notification over the network(s) 3104 to the server(s) 3102, which may send the authorization notification to the POS system 3124 over the network(s) 3104 to indicate whether the transaction is authorized. The server(s) 3102 may also transmit additional information such as transaction identifiers to the POS system 3124. In one example, the server(s) 3102 may include a merchant application and/or other functional components for communicating with the POS system 3124 and/or the server(s) 3110 to authorize or decline transactions.

Based on the authentication notification that is received by the POS system 3124 from server(s) 3102, the merchant 3116(A) may indicate to the customer 3120 whether the transaction has been approved. In some examples, approval may be indicated at the POS system 3124, for example, at a display of the POS system 3124. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, and so on. In some examples, the users 3114 can access all of the services of the service provider. In other examples, the users 3114 can have gradated access to the services, which can be based on risk tolerance, IDV outputs, subscriptions, type of account with the service provider (e.g., merchant versus customer), and so on. In at least one example, access to such services can be availed to the merchants 3116 via the POS application 3118. In additional or alternative examples, each service can be associated with its own access point (e.g., application, web browser, etc.).

The service provider can offer payment processing services for processing payments on behalf of the merchants 3116, as described above. For example, the service provider can provision payment processing software, payment processing hardware and/or payment processing services to merchants 3116, as described above, to enable the merchants 3116 to receive payments from the customers 3120 when conducting POS transactions with the customers 3120. For instance, the service provider can enable the merchants 3116 to receive cash payments, payment card payments, and/or electronic payments from customers 3120 for POS transactions and the service provider can process transactions on behalf of the merchants 3116.

As the service provider processes transactions on behalf of the merchants 3116, the service provider can maintain accounts or balances for the merchants 3116 in one or more ledgers. For example, the service provider can analyze transaction data received for a transaction to determine an amount of funds owed to a merchant 3116(A) for the transaction. In at least one example, such an amount can be a total purchase price less fees charged by the service provider for providing the payment processing services. Based on determining the amount of funds owed to the merchant 3116(A), the service provider can deposit funds into an account of the merchant 3116(A). The account can have a stored balance, which can be managed by the service provider. The account can be different from a conventional bank account at least because the stored balance is managed by a ledger of the service provider and the associated funds are accessible via various withdrawal channels including, but not limited to, scheduled deposit, same-day deposit, instant deposit, and a linked payment instrument.

A scheduled deposit can occur when the service provider transfers funds associated with a stored balance of the merchant 3116(A) to a bank account of the merchant 3116(A) that is held at a bank or other financial institution (e.g., associated with the server(s) 3110). Scheduled deposits can occur at a prearranged time after a POS transaction is funded, which can be a business day after the POS transaction occurred, or sooner or later. In some examples, the merchant 3116(A) can access funds prior to a scheduled deposit. For instance, the merchant 3116(A) may have access to same-day deposits (e.g., wherein the service provider deposits funds from the stored balance to a linked bank account of the merchant on a same day as POS transaction, in some examples prior to the POS transaction being funded) or instant deposits (e.g., wherein the service provider deposits funds from the stored balance to a linked bank account of the merchant on demand, such as responsive to a request). Further, in at least one example, the merchant 3116(A) can have a payment instrument that is linked to the stored balance that enables the merchant to access the funds without first transferring the funds from the account managed by the service provider to the bank account of the merchant 3116(A).

In at least one example, the service provider may provide inventory management services. That is, the service provider may provide inventory tracking and reporting. Inventory management services may enable the merchant 3116(A) to access and manage a database storing data associated with a quantity of each item that the merchant 3116(A) has available (i.e., an inventory). Furthermore, in at least one example, the service provider can provide catalog management services to enable the merchant 3116(A) to maintain a catalog, which can be a database storing data associated with items that the merchant 3116(A) has available for acquisition (i.e., catalog management services). In at least one example, the catalog may include a plurality of data items and a data item of the plurality of data items may represent an item that the merchant 3116(A) has available for acquisition. The service provider can offer recommendations related to pricing of the items, placement of items on the catalog, and multi-party fulfillment of the inventory.

In at least one example, the service provider can provide business banking services, which allow the merchant 3116(A) to track deposits (from payment processing and/or other sources of funds) into an account of the merchant 3116(A), payroll payments from the account (e.g., payments to employees of the merchant 3116(A)), payments to other merchants (e.g., business-to-business) directly from the account or from a linked debit card, withdrawals made via scheduled deposit and/or instant deposit, etc. Furthermore, the business banking services can enable the merchant 3116(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 3116 to visualize their cash flow to track their financial health, set aside money for upcoming obligations (e.g., savings), organize money around goals, etc.

In at least one example, the service provider can provide financing services and products, such as via business loans, consumer loans, fixed term loans, flexible term loans, and the like. In at least one example, the service provider can utilize one or more risk signals to determine whether to extend financing offers and/or terms associated with such financing offers.

In at least one example, the service provider can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider can offer different types of capital loan products. For instance, in at least one example, the service provider can offer a daily repayment loan product, wherein a capital loan is repaid daily, for instance, from a portion of transactions processed by the payment processing service on behalf of the borrower. Additionally and/or alternatively, the service provider can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on.

Additionally or alternatively, the service provider can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which can be one of the merchants 3116. The service provider can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider (e.g., from payments owed to the merchant from payments processed on behalf of the merchant, funds transferred to the merchant, etc.). The service provider can offer specific financial products, such as payment instruments, tied specifically to the loan products. For example, in one implementation, the service provider associates capital to a merchant or customer's debit card, where the use of the debit card is defined by the terms of the loan. In some examples, the merchant may use the debit card for making specific purchases. In other examples, the “installment” associated with the loan product is credited directly via the payment instrument. The payment instrument is thus customized to the loan and/or the parties associated with the loan.

The service provider can provide web-development services, which enable users 3114 who are unfamiliar with HTML, XML, JavaScript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by one or more of the merchants 3116. In at least one example, the service provider can recommend and/or generate content items to supplement omni-channel presences of the merchants 3116. That is, if a merchant of the merchants 3116 has a web page, the service provider—via the web-development or other services—can recommend and/or generate additional content items to be presented via other channel(s), such as social media, email, etc.

Furthermore, the service provider can provide payroll services to enable employers to pay employees for work performed on behalf of employers. In at least one example, the service provider can receive data that includes time worked by an employee (e.g., through imported timecards and/or POS interactions), sales made by the employee, gratuities received by the employee, and so forth. Based on such data, the service provider can make payroll payments to employee(s) on behalf of an employer via the payroll service. For instance, the service provider can facilitate the transfer of a total amount to be paid out for the payroll of an employee from the bank of the employer to the bank of the service provider to be used to make payroll payments, or from a digital wallet of the employer to a digital wallet of the service provider to be used to make the payroll payments. In at least one example, when the funds have been received at the bank of the service provider, the service provider can pay the employee, such as by check or direct deposit, often a day, a week, or more after when the work was actually performed by the employee. In additional or alternative examples, the service provider can enable employee(s) to receive payments via same-day or instant deposit based at least in part on risk and/or reliability analyses performed by the service provider. Additionally or alternatively, the service provider can enable employee(s) to receive cryptocurrency payments (or other digital assets) to digital wallets.

Moreover, in at least one example, the service provider can provide employee management services for managing schedules of employees. Further, the service provider can provide appointment services for enabling users 3114 to set schedules for scheduling appointments and/or users 3114 to schedule appointments.

In some examples, the service provider can provide restaurant management services to enable users 3114 to make and/or manage reservations, to monitor front-of-house and/or back-of-house operations, and so on. In such examples, the merchant device(s) 3108 and/or server(s) 3102 can be configured to communicate with one or more other computing devices, which can be located in the front-of-house (e.g., POS device(s)) and/or back-of-house (e.g., kitchen display system(s) (KDS)). In at least one example, the service provider can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider can provide fulfilment services, which can use couriers for delivery, wherein couriers can travel between multiple locations to provide delivery services, photography services, etc. Couriers can be users 3114 who can travel between locations to perform services for a requesting user 3114 (e.g., deliver items, capture images, etc.). In some examples, the courier can receive compensation from the service provider. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider can receive requests for courier services, automatically assign the requests to active couriers, and communicate dispatch instructions to couriers via user interface (e.g., application, web browser, or other access point) presented via respective devices 3106.

In some examples, the service provider can provide omni-channel fulfillment services. For instance, if a customer places an order with a merchant and the merchant cannot fulfill the order because one or more items are out of stock or otherwise unavailable, the service provider can leverage other merchants and/or sales channels that are part of the platform of the service provider to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider can enable conversational commerce via conversational commerce services, which can use one or more machine learning mechanisms to analyze messages exchanged between two or more users 3114, voice inputs into a virtual assistant or the like, to determine intents of user(s) 3114. In some examples, the service provider can utilize determined intents to automate customer service, offer promotions, provide recommendations, or otherwise interact with customers in real-time. In at least one example, the service provider can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 3114 may be new to the service provider such that the user 3114 that has not registered (e.g., subscribed to receive access to one or more services offered by the service provider) with the service provider. The service provider can offer onboarding services for registering a potential user 3114 with the service provider. In some examples, onboarding can involve presenting various questions, prompts, and the like to a potential user 3114 to obtain information that can be used to generate a profile for the potential user 3114. In at least one example, the service provider can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 3114 providing the necessary information, the potential user 3114 can be onboarded to the service provider. In such an example, any limited or short-term access to services of the service provider can be transitioned to more permissive (e.g., less limited) or longer-term access to such services.

The service provider can be associated with IDV services, which can be used by the service provider for compliance purposes and/or can be offered as a service, for instance to third-party service providers (e.g., associated with the server(s) 3110). That is, the service provider can offer IDV services to verify the identity of users 3114 seeking to use or using their services. Identity verification requires a customer (or potential customer) to provide information that is used by compliance departments to prove that the information is associated with an identity of a real person or entity. In at least one example, the service provider can perform services for determining whether identifying information provided by a user 3114 accurately identifies the customer (or potential customer) (i.e., Is the customer who they say they are?).

The service provider is capable of providing additional or alternative services and the services described above are offered as a sampling of services. In at least one example, the service provider can exchange data with the server(s) 3110 associated with third-party service providers. Such third-party service providers can provide information that enables the service provider to provide services, such as those described above. In additional or alternative examples, such third-party service providers can access services of the service provider. That is, in some examples, the third-party service providers can be subscribers, or otherwise access, services of the service provider.

Techniques described herein can be configured to operate in both real-time/online and offline modes. “Online” modes refer to modes when devices are capable of communicating with the service provider (e.g., the server(s) 3102) and/or the server(s) 3110 via the network(s) 3104. In some examples, the merchant device(s) 3108 are not capable of connecting with the service provider (e.g., the server(s) 3102) and/or the server(s) 3110, due to a network connectivity issue, for example. In additional or alternative examples, the server(s) 3102 are not capable of communicating with the server(s) 3110 due to network connectivity issue, for example. In such examples, devices may operate in “offline” mode where at least some payment data is stored (e.g., on the merchant device(s) 3108) and/or the server(s) 3102 until connectivity is restored and the payment data can be transmitted to the server(s) 3102 and/or the server(s) 3110 for processing.

In at least one example, the service provider can be associated with a hub, such as an order hub, an inventory hub, a fulfillment hub and so on, which can enable integration with one or more additional service providers (e.g., associated with the additional server(s) 3110). In some examples, such additional service providers can offer additional or alternative services and the service provider can provide an interface or other computer-readable instructions to integrate functionality of the service provider into the one or more additional service providers.

Techniques described herein are directed to services provided via a distributed system of user devices 3106 that are in communication with server(s) 3102 of the service provider. That is, techniques described herein are directed to a specific implementation—or a practical application—of utilizing a distributed system of user devices 3106 that are in communication with server(s) 3102 of the service provider to perform a variety of services, as described above. The unconventional configuration of the distributed system described herein enables the server(s) 3102 that are remotely-located from end-users (e.g., users 3114) to intelligently offer services based on aggregated data associated with the end-users, such as the users 3114 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein continuously or periodically monitor disparate and distinct merchant accounts, e.g., accounts within the control of the service provider, and those outside of the control of the service provider, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (a merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 3114 and user devices 3106. Furthermore, such features are changed dynamically based on the profiles of the users involved interacting with the GUIs. As such, techniques described herein are directed to improvements to computing systems.

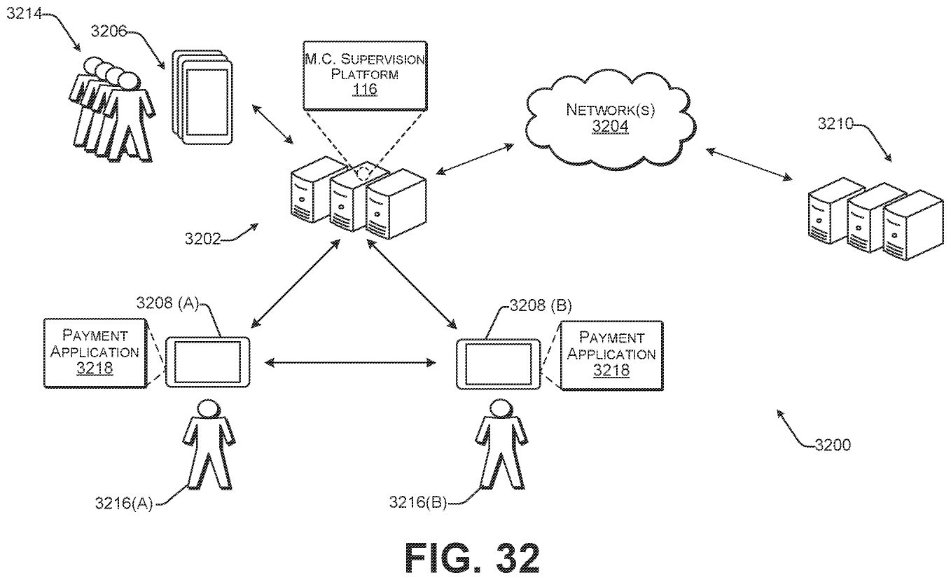

FIG. 32 illustrates an example environment 3200. The environment 3200 includes server(s) 3202 that can communicate over a network 3204 with user devices 3206 (which, in some examples can be user devices 3208 (individually, 3208(A), 3208(B)) and/or server(s) 3210 associated with third-party service provider(s). The server(s) 3202 can be associated with a service provider that can provide one or more services for the benefit of users 3214, as described below. Actions attributed to the service provider can be performed by the server(s) 3202. In some examples, the service provider referenced in FIG. 31 can be the same or different than the service provider referenced in FIG. 32.

In the context of previously described figures, for example, at least a portion of the server(s) 3202 and/or the server(s) 3210 may be used to implement the media content supervision platform 116 and/or various portions of the media content service provider system 102.

The environment 3200 can include a plurality of user devices 3206, as described above. Each one of the plurality of user devices 3206 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IOT) device, etc. In some examples, individual ones of the user devices can be operable by users 3214. The users 3214 can be referred to as customers, buyers, merchants, sellers, borrowers, employees, employers, payors, payees, couriers and so on. The users 3214 can interact with the user devices 3206 via user interfaces presented via the user devices 3206, such as one or more of the user interfaces depicted in FIGS. 3-28. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 3206 can have an instance or versioned instance of an application, which can be downloaded from an application store, for example, which can present the user interface(s) described herein. In at least one example, a user 3214 can interact with the user interface via touch input, spoken input, or any other type of input.

In at least one example, the service provider can provide a peer-to-peer payment service that enables peer-to-peer payments between two or more users 3214. Two users, user 3216(A) and user 3216(B) are illustrated in FIG. 32 as “peers” in a peer-to-peer payment. In at least one example, the service provider can communicate with instances of a payment application 3218 (or other access point) installed on devices 3206 configured for operation by users 3214. In another example, an instance of the payment application 3218 executing on a first device 3208(A) operated by a payor (e.g., user 3216(A)) can send a request to the service provider to transfer an asset (e.g., fiat currency, non-fiat currency, digital assets, cryptocurrency, securities, gift cards, and/or related assets) from the payor to a payee (e.g., user 3216(B)) via a peer-to-peer payment. In some examples, assets associated with an account of the payor are transferred to an account of the payee, and an instance of the payment application 3218 executing on a second device 3208(B) operated by the payee (e.g., user 3216(B)) can display a control to accept the transaction and/or a notification that the transaction was executed. In some examples, assets can be held at least temporarily in an account of the service provider prior to transferring the assets to the account of the payee.

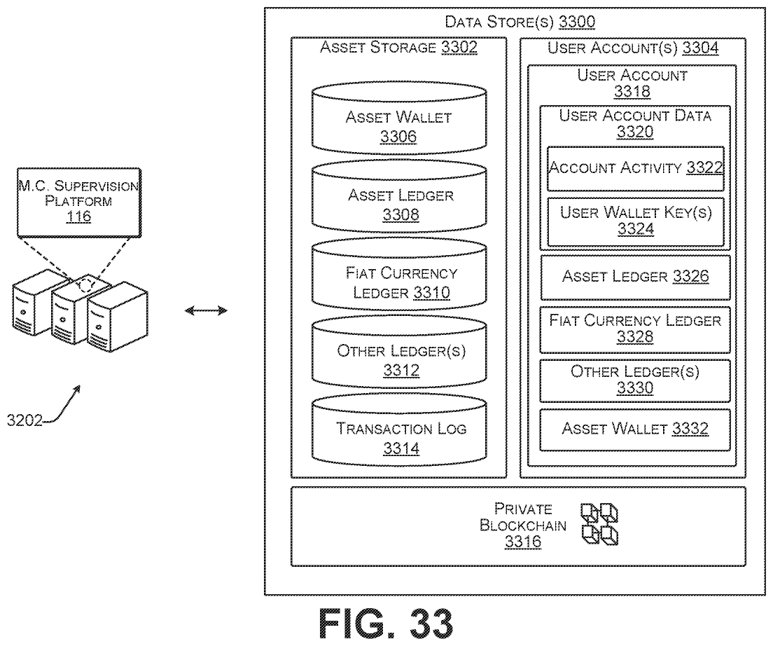

In some examples, the service provider can utilize a ledger system to track transfers of assets between users 3214. FIG. 33, below, provides additional details associated with such a ledger system. The ledger system can enable users 3214 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment application 3218 executing on user device(s) of payee(s). As an example, the service provider can transfer assets from an account of user 3216(A) to an account of the user 3216(B) and can send a notification to the user device 3208(B) of the user 3216(B) for presentation via a user interface. The notification can indicate that a transfer is in process, a transfer is complete, or the like. In some examples, the service provider can send additional or alternative information to the instances of the payment application 3218 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider funds the request to payee on behalf of the payor, to speed up the transfer process and compensate for any lags that may be attributed to the payor's financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 3202 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 3218 executing on the user devices 3206. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, the content provider can be the service provider as described with reference to FIG. 32 or a third-party service provider associated with the server(s) 3210. In examples where the content provider is a third-party service provider, the server(s) 3210 can be accessible via one or more APIs or other integrations. The forum can be employed by a content provider to enable users of the forum to interact with one another (e.g., through creating messages, posting comments, etc.). In some examples, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider referenced in FIG. 32. For instance, the service provider can offer messaging services that provide a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 3206 (e.g., mobile device or conventional personal computer (PC)) based on instructions transmitted to and from the server(s) 3202 (which, in such an example can be called a “messaging server”). In some instances, the messaging application can include a payment application with messaging capability that enables users of the payment application to communicate with one another. In such instances, the payment application can be executed on a user device 3206 based on instructions transmitted to and from the server(s) 3202 (e.g., the payment service discussed in this description or another payment service that supports payment transactions). In some examples, the messaging application can be provided by a third-party service provider associated with the server(s) 3210. In examples where the messaging application is a third-party service provider, the server(s) 3210 can be accessible via one or more APIs or other integrations.

As described above, the service provider can facilitate peer-to-peer transactions, which can enable users 3214 to transfer fiat currency, non-fiat currency, cryptocurrency, securities, or other assets, or portions thereof, to other users 3214. In at least one example, individual users can be associated with user accounts. Additional details associated with user accounts and the transfer of assets between users 3214 are described below with reference to FIG. 33.

Furthermore, the service provider of FIG. 32 can enable users 3214 to perform banking transactions via instances of the payment application 3218. For example, users can configure direct deposits or other deposits for adding assets to their various ledgers/balances. Further, users 3214 can configure bill pay, recurring payments, and/or the like using assets associated with their accounts. In addition to sending and/or receiving assets via peer-to-peer transactions, users 3214 buy and/or sell assets via asset networks such as cryptocurrency networks, securities networks, and/or the like.

FIG. 33 illustrates example data store(s) 3300 that can be associated with the server(s) 3202.

In at least one example, the data store(s) 3300 can store assets in an asset storage 3302, as well as data in user account(s) 3304. In some examples, user account(s) 3304 can include merchant account(s) and/or customer account(s). In at least one example, the asset storage 3302 can be used to store assets managed by the service provider of FIG. 32. In at least one example, the asset storage 3302 can be used to record whether individual of the assets are registered to users. For example, the asset storage 3302 can include an asset wallet 3306 for storing records of assets owned by the service provider of FIG. 32, such as cryptocurrency, tokens (e.g., NFTs), digital content (e.g., music, videos, images, etc.), securities, or the like, and communicating with one or more asset networks, such as cryptocurrency networks, token networks, content exchange networks, securities networks, or the like. In some examples, the asset network can be a first-party network or a third-party network, such as a cryptocurrency exchange, an NFT exchange, or the stock market. In examples where the asset network is a third-party network, the server(s) 3210 can be associated therewith. In some examples, the asset wallet 3306 can communicate with the asset network via one or more components associated with the server(s) 3202.

The asset wallet 3306 can be associated with one or more addresses and can vary addresses used to acquire assets (e.g., from the asset network(s)) so that its holdings are represented under a variety of addresses on the asset network. In examples where the service provider of FIG. 32 has its own holdings of cryptocurrency (e.g., in the asset wallet 3306), a user can acquire cryptocurrency directly from the service provider of FIG. 32. In some examples, the service provider of FIG. 32 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In these various scenarios, the buying and selling of cryptocurrency, and therefore the associated updating of the public ledger of the asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 3302 may contain ledgers that store records of assignments of assets to users 3214. Specifically, the asset storage 3302 may include asset wallet 3306, asset ledger 3308, fiat currency ledger 3310, and other ledger(s) 3312, which can be used to record transfers of assets between users 3214 of the service provider and/or one or more third-parties (e.g., merchant network(s), payment card network(s), ACH network(s), equities network(s), the asset network, securities networks, content licensing and distributing network(s), etc.). In doing so, the asset storage 3302 can maintain a running balance of assets managed by the service provider of FIG. 32. The ledger(s) of the asset storage 3302 can further indicate some of the running balance for each of the ledger(s) stored in the asset storage 3302 is assigned or registered to one or more user account(s) 3304.

In at least one example, the asset storage 3302 can include transaction logs 3314, which can include records of past transactions involving the service provider of FIG. 32. In at least one example, transaction data, as described herein, can be stored in association with the transaction logs 3314.

In some examples, the data store(s) 3300 can store a private blockchain 3316. A private blockchain 3316 can function to record sender addresses, recipient addresses, public keys, values of cryptocurrency transferred, and/or can be used to verify ownership of cryptocurrency tokens to be transferred. In some examples, the service provider of FIG. 32 can record transactions taking place within the service provider of FIG. 32 involving cryptocurrency until the number of transactions has exceeded a determined limit (e.g., number of transactions, storage space allocation, etc.). Based at least in part on determining that the limit has been reached, the service provider of FIG. 32 can publish the transactions in the private blockchain 3316 to a public blockchain (e.g., associated with the asset network), where miners can verify the transactions and record the transactions to blocks on the public blockchain. In at least one example, the service provider of FIG. 32 can participate as miner(s) at least for its transactions to be posted to the public blockchain.

In at least one example, the data store(s) 3300 can store and/or manage accounts, such as user account(s) 3304, merchant account(s), and/or customer account(s). In at least one example, the user account(s) 3304 may store records of user accounts associated with the users 3214. In at least one example, the user account(s) 3304 can include a user account 3318, which can be associated with a user (of the users 3214). Other user accounts of the user account(s) 3304 can be similarly structured to the user account 3318, according to some examples. In other examples, other user accounts may include more or less data and/or account information than that provided by the user account 3318. In at least one example, the user account 3318 can include user account data 3320, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment assets used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 3320 can include account activity 3322 and user wallet key(s) 3324. The account activity 3322 may include a transaction log for recording transactions associated with the user account 3318. In some examples, the user wallet key(s) 3324 can include a public-private key-pair and a respective address associated with the asset network or other asset networks. In some examples, the user wallet key(s) 3324 may include one or more key pairs, which can be unique to the asset network or other asset networks.

In addition to the user account data 3320, the user account 3318 can include ledger(s) for account(s) managed by the service provider of FIG. 32, for the user. For example, the user account 3318 may include an asset ledger 3326, a fiat currency ledger 3328, and/or one or more other ledgers 3330. The ledger(s) can indicate that a corresponding user utilizes the service provider of FIG. 32 to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider of FIG. 32.

In some examples, the asset ledger 3326 can store a balance for each of one or more cryptocurrencies (e.g., Bitcoin, Ethereum, Litecoin, etc.) registered to the user account 3318. In at least one example, the asset ledger 3326 can further record transactions of cryptocurrency assets associated with the user account 3318. For example, the user account 3318 can receive cryptocurrency from the asset network using the user wallet key(s) 3324. In some examples, the user wallet key(s) 3324 may be generated for the user upon request. User wallet key(s) 3324 can be requested by the user in order to send, exchange, or otherwise control the balance of cryptocurrency held by the service provider of FIG. 32 (e.g., in the asset wallet 3306) and registered to the user. The asset ledger 3326 can further record transactions of other digital assets associated with the user account 3318, and the user account 3318 can receive such assets from the asset network using the user wallet key(s) 3324. In some examples, the user wallet key(s) 3324 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider of FIG. 32 and the value is credited as a balance in asset ledger 3326), by purchasing currency in the form associated with the account using currency in a different form (e.g., buying a value of cryptocurrency from the service provider of FIG. 32 using a value of fiat currency reflected in fiat currency ledger 3328, and crediting the value of cryptocurrency in asset ledger 3326), or by conducting a transaction with another user (customer or merchant) of the service provider of FIG. 32 wherein the account receives incoming currency (which can be in the form associated with the account or a different form, in which the incoming currency may be converted to the form associated with the account). In some examples, the user account data 3320 can include preferences for maintaining balances of individual of the ledgers. For example, the service provider of FIG. 32 can automatically debit the fiat currency ledger 3328 to increase the asset ledger 3326, or another account associated with the user whenever the cryptocurrency balance (e.g., of the asset ledger 3326) falls below a stated level (e.g., a threshold). Conversely, in some embodiments, the service provider of FIG. 32 can automatically credit the fiat currency ledger 3328 to decrease the asset ledger 3326 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet can be associated with a third-party unrelated to the service provider of FIG. 32 (i.e., an external account). In at least one example, the user can transfer a balance of the cryptocurrency (or a portion of the balance) stored in the third-party cryptocurrency wallet to the service provider of FIG. 32. Such a transaction can require the user to transfer an amount of the cryptocurrency in a message signed by user's private key to an address provided by the service provider of FIG. 32. In at least one example, the transaction can be sent to miners to bundle the transaction into a block of transactions and to verify the authenticity of the transactions in the block. Once a miner has verified the block, the block is written to a public, distributed blockchain where the service provider of FIG. 32 can then verify that the transaction has been confirmed and can credit the user's asset ledger 3326 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 32. As described above, in some examples, the service provider of FIG. 32 can acquire cryptocurrency from a third-party source. In such examples, the asset wallet 3306 can be associated with different addresses and can vary addresses used to acquire cryptocurrency so that its holdings are represented under a variety of addresses on a blockchain. When the service provider of FIG. 32 has their own holdings of cryptocurrency, users can acquire cryptocurrency directly from the service provider of FIG. 32. In some examples, the service provider of FIG. 32 can include logic for buying and selling cryptocurrency in order to maintain a desired level of cryptocurrency. The desired level can be based on a volume of transactions over a period, balances of collective user profiles' cryptocurrency ledgers, exchange rates, or trends in changing of exchange rates such that the cryptocurrency is trending towards gaining or losing value with respect to the fiat currency. In the various examples, the buying and selling of cryptocurrency, and therefore the associated updating of the public ledger can be separate from any customer-merchant transaction, and therefore not necessarily time-sensitive.

In examples where the service provider of FIG. 32 has its own cryptocurrency assets, cryptocurrency transferred in a transaction (e.g., data with address provided for receipt of transaction and a balance of cryptocurrency transferred in the transaction) can be stored in the asset wallet 3306. In at least one example, the service provider of FIG. 32 can credit the asset ledger 3326 of the user. Additionally, while the service provider of FIG. 32 recognizes that the user retains the value of the transferred cryptocurrency through crediting the asset ledger 3326, any person that inspects the blockchain will see the cryptocurrency as having been transferred to the service provider of FIG. 32. In some examples, the asset wallet 3306 can be associated with many different addresses. In such examples, any person that inspects the blockchain may not easily associate the cryptocurrency stored in asset wallet 3306 as belonging to the same entity. It is this presence of a private ledger that is used for real-time transactions and maintained by the service provider of FIG. 32, combined with updates to the public ledger at other times, that allows for extremely fast transactions using cryptocurrency to be achieved. In some examples, the “private ledger” can refer to the asset ledger 3308, which in some examples, can utilize the private blockchain 3316, as described herein. The “public ledger” can correspond to a public blockchain associated with the asset network.

In at least one example, a user's asset ledger 3326, fiat currency ledger 3328, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 3326. In some examples, a user can receive fiat currency or another currency in the form of payment for a transaction with another user. In at least one example, at least a portion of such funds can be converted into cryptocurrency by the service provider of FIG. 32 and used to fund the asset ledger 3326 of the user.

As addressed above, in some examples, users can also have other accounts maintained by the service provider of FIG. 32. For example, a user can also have an account in U.S. dollars, which can be tracked, for example, via the fiat currency ledger 3328. Such an account can be funded by transferring money from a bank account at a third-party bank to an account maintained by the service provider of FIG. 32 as is conventionally known. In some examples, a user can receive fiat currency in the form of payment for a transaction with another user. In such examples, at least a portion of such funds can be used to fund the fiat currency ledger 3328.

In some examples, a user can have one or more internal payment cards registered with the service provider of FIG. 32. Internal payment cards can be linked to one or more of the accounts associated with the user account 3318. In some embodiments, options with respect to internal payment cards can be adjusted and managed using an application (e.g., the payment application 3218).

In at least one example, as described above, each ledger can correspond to an account of the user that is managed by the service provider of FIG. 32. In at least one example, individual of the accounts can be associated with a wallet or a stored balance for use in payment transactions, peer-to-peer transactions, payroll payments, etc.

In at least one example, the user account 3318 can be associated with an asset wallet 3332. The asset wallet 3332 of the user can be associated with account information that can be stored in the user account data 3320 and, in some examples, can be associated with the user wallet key(s) 3324. In at least one example, the asset wallet 3332 can store data indicating an address provided for receipt of a cryptocurrency transaction, a blockchain token-based transaction, or a transaction for another digital asset implemented using a blockchain, to name just a few. In at least one example, the balance of the asset wallet 3332 can be based at least in part on a balance of the asset ledger 3326. In at least one example, funds availed via the asset wallet 3332 can be stored in the asset wallet 3332 or the asset wallet 3306. Funds availed via the asset wallet 3306 can be tracked via the asset ledger 3326. The asset wallet 3332, however, can be associated with additional cryptocurrency funds and other digital assets.

In at least one example, when the service provider of FIG. 32 includes a private blockchain 3316 for recording and validating cryptocurrency transactions, the asset wallet 3332 can be used instead of, or in addition to, the asset ledger 3326. For example, at least one example, a merchant can provide the address of the asset wallet 3332 for receiving payments. In an example where a customer is paying in cryptocurrency and the customer has their own cryptocurrency wallet account associated with the service provider of FIG. 32, the customer can send a message signed by its private key including its wallet address (i.e., of the customer) and identifying the cryptocurrency and value to be transferred to the merchant's asset wallet 3332. The service provider of FIG. 32 can complete the transaction by reducing the cryptocurrency balance in the customer's cryptocurrency wallet and increasing the cryptocurrency balance in the merchant's asset wallet 3332. In addition to recording the transaction in the respective cryptocurrency wallets, the transaction can be recorded in the private blockchain 3316, and the transaction can be confirmed. A user can perform a similar transaction with cryptocurrency in a peer-to-peer transaction as described above. In at least one example, the cryptocurrency wallet account can be funded by a balance transfer from a third-party cryptocurrency wallet, as described above. Such a transaction can require a user to transfer an amount of cryptocurrency in a message signed by the user's private key to an address of the cryptocurrency wallet account. The transferred amount of cryptocurrency can then be within the cryptocurrency wallet account for use in later transactions.

While the asset ledger 3326 and/or asset wallet 3332 are each described above with reference to cryptocurrency, the asset ledger 3326 and/or asset wallet 3332 can alternatively be used in association with securities and other digital assets, such as tokens (e.g., NFTs), smart contracts, and so forth. In some examples, different ledgers and/or wallets can be used for different types of assets. That is, in some examples, a user can have multiple asset ledgers and/or asset wallets for tracking cryptocurrency, securities, tokens (e.g., NFTs), smart contracts, or the like.

It should be noted that user(s) having accounts managed by the service provider of FIG. 32 is an aspect of the technology disclosed that enables technical advantages of increased processing speed and improved security.

FIG. 34 illustrates an example environment 3400 wherein the environment 3100 and the environment 3200 can be integrated to enable payments at the point-of-sale using assets associated with user accounts in the peer-to-peer environment of FIG. 32. As illustrated, each of the components can communicate with one another via one or more networks 3402. In some examples, one or more APIs 3404 or other functional components can be used to facilitate such communication.

In at least one example, the example environment 3400 can enable contactless payments, via integration of peer-to-peer payment, or other payment making, platform(s) and payment processing platform(s), are described herein. For the purpose of FIG. 34, the environment 3100 can refer to a payment processing platform and the environment 3200 can refer to a peer-to-peer payment, or payment making, platform. In an example, such an integration can enable a customer to participate in a transaction via their own computing device instead of interacting with a merchant device of a merchant, such as the merchant device 3108(A). In such an example, the POS application 3118, associated with a payment processing platform and executable by the merchant device 3108(A) of the merchant, can present a Quick Response (QR) code, or other code that can be used to identify a transaction (e.g., a transaction code), in association with a transaction between the customer and the merchant. The QR code, or other transaction code, can be provided to the POS application 3118 via an API associated with the peer-to-peer payment platform. In an example, the customer can utilize their own computing device, such as the user device 3208(A), to capture the QR code, or the other transaction code, and to provide an indication of the captured QR code, or other transaction code, to server(s) 3102 and/or server(s) 3202.

Based at least in part on the integration of the peer-to-peer payment platform and the payment processing platform (e.g., via the API), the server(s) 3102 and/or 3202 associated with each can exchange communications with each other—and with a payment application 3218 associated with the peer-to-peer payment platform and/or the POS application 3118—to process payment for the transaction using a peer-to-peer payment where the customer is a first “peer” and the merchant is a second “peer.” In at least one example, the peer-to-peer payment platform can transfer funds from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which can be a first- or third-party integration) such that a QR code, or other transaction code, specific to the transaction can be used for providing transaction details, location details, customer details, or the like to a computing device of the customer, such as the user device 3208(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 3208(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 3118 and the payment application 3218, as described herein, can process a payment transaction by routing information input via the merchant application to the payment application for completing a “frictionless” payment. This can be referred to as “in-application payment.” In another example of “in-application payment,” the payment application described herein can be created or modified via a software developer kit (SDK) to enable in-application payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 3208(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 3118, associated with a payment processing platform, on the merchant device 3108(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, a display of the merchant device 3108(A) can present a QR code, or other transaction code, that can be associated with a peer-to-peer payment platform. The customer can use a camera associated with the user device 3208(A) to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 3118, associated with a payment processing platform, on the merchant device 3108(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, the POS application 3118 can cause a text message with a resource locator (e.g., uniform resource locator (URL)) that can be associated with a peer-to-peer payment platform to be sent to the user device 3208(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform. This interaction—between the customer and the resource locator presented via the customer computing device—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. As described above, such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques can be applicable in online and/or ecommerce selling channels as well. In such an example, a QR code, or other transaction code, can be presented via an online store/ecommerce web page of a merchant. The customer can use a camera associated with a customer computing device, such as the user device 3208(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 3118 of a merchant device 3108(A) at a brick-and-mortar store of a merchant to a payment application 3218 of a user device 3208(A) of a customer to enable the customer to participate in a transaction via their own computing device. For instance, in a “scan to pay” example as described above, based at least in part on capturing the QR code, or other transaction code, via the user device 3208(A), the payment processing platform can provide transaction data to the peer-to-peer payment platform for presentation via the payment application 3218 on the user device 3208(A). In some examples, the customer can watch items being added to their cart (e.g., via a user interface presented via the payment application). As an item is added to a virtual cart by the merchant—via the POS application 3118 on the merchant device 3108(A) of the merchant—the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment application 3218 for presentation via a user interface associated therewith. In addition to enabling a customer to participate in a transaction during cart building, techniques described herein can enable a customer to complete a transaction, and in some examples, provide gratuity (i.e., a tip), feedback, loyalty information, or the like, via the user device 3208(A) during or after payment of the transaction.

In some examples, based at least in part on capturing the QR code, or other transaction code, the payment processing platform can provide transaction data to the peer-to-peer payment platform for presentation via the payment application 3218 on the computing device of the customer, such as the user device 3208(A), to enable the customer to complete the transaction via their own computing device. In some examples, in response to receiving an indication that the QR code, or other transaction code, has been captured or otherwise interacted with via the customer computing device, the peer-to-peer payment platform can determine that the customer authorizes payment of the transaction using funds associated with a stored balance of the customer that is managed and/or maintained by the peer-to-peer payment platform. Such authorization can be implicit such that the interaction with the transaction code can imply authorization of the customer. In some examples, in response to receiving an indication that the QR code, or other transaction code, has been captured or otherwise interacted with via the customer computing device, the peer-to-peer payment platform can request authorization to process payment for the transaction using the funds associated with the stored balance and the customer can interact with the payment application to authorize the settlement of the transaction. A response to such a request can provide an express authorization of the customer. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the peer-to-peer payment platform can transfer funds from the stored balance of the customer to the payment processing platform. In at least one example, the payment processing platform can deposit the funds, or a portion thereof, into a stored balance of the merchant that is managed and/or maintained by the payment processing platform. That is, techniques described herein enable the peer-to-peer payment platform to transfer funds to the payment processing platform to settle payment of the transaction. In such an example, the payment processing platform can be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a user interface associated with the payment application 3218 such that the customer can provide gratuity, feedback, loyalty information, or the like, via an interaction with the user interface. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the user interface presented by the payment application, which can be associated with the transaction.

As described above—and also below—techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection user interface being presented via the POS application 3118, payment for the transaction can be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 3218 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, instead of scanning, capturing, or otherwise interacting with a QR code or transaction code, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. For example, based at least in part on detecting a dip, tap, swipe, or the like, the payment processing platform can associate a customer with a transaction and provide at least a portion of transaction data associated with the transaction to a customer computing device associated therewith. In some examples, the payment instrument can be associated with the peer-to-peer payment platform as described herein (e.g., a debit card linked to a stored balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

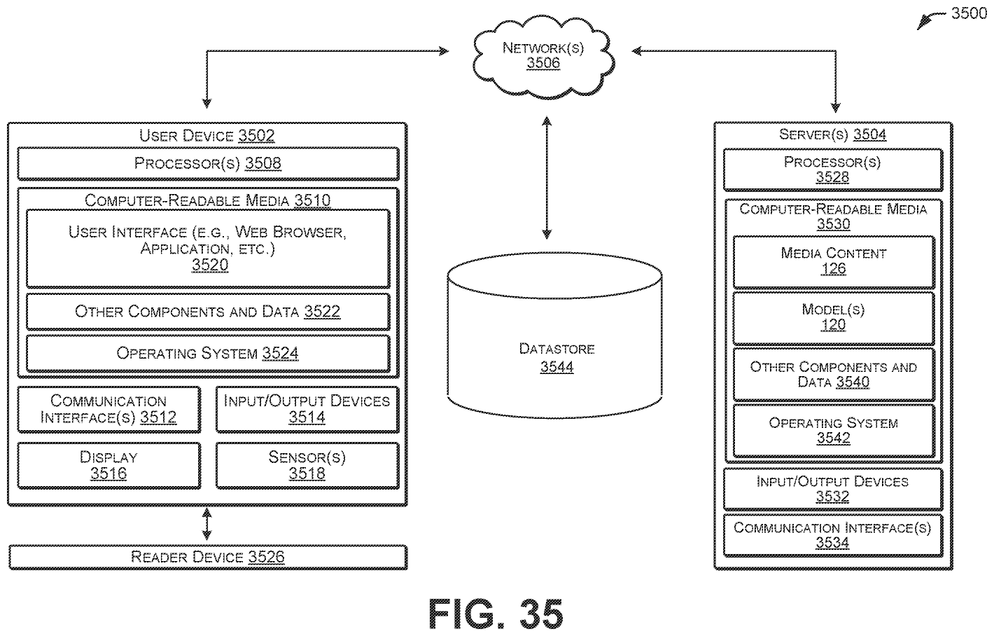

FIG. 35 depicts an illustrative block diagram illustrating a system 3500 for performing techniques described herein. The system 3500 includes a user device 3502, that communicates with server computing device(s) (e.g., server(s) 3504) via network(s) 3506 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 3502 is illustrated, in additional or alternate examples, the system 3500 can have multiple user devices, as described above with reference to FIG. 31 and FIG. 32.

In at least one example, the user device 3502 can be any suitable type of computing device, e.g., portable, semi-portable, semi-stationary, or stationary. Some examples of the user device 3502 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IOT) device, etc. That is, the user device 3502 can be any computing device capable of sending communications and performing the functions according to the techniques described herein. The user device 3502 can include devices, e.g., payment card readers, or components capable of accepting payments, as described below.

In the illustrated example, the user device 3502 includes one or more processors 3508, one or more computer-readable media 3510, one or more communication interface(s) 3512, one or more input/output (I/O) devices 3514, a display 3516, and sensor(s) 3518.

In at least one example, each processor 3508 can itself comprise one or more processors or processing cores. For example, the processor(s) 3508 can be implemented as one or more microprocessors, microcomputers, microcontrollers, digital signal processors, central processing units, state machines, logic circuitries, and/or any devices that manipulate signals based on operational instructions. In some examples, the processor(s) 3508 can be one or more hardware processors and/or logic circuits of any suitable type specifically programmed or configured to execute the algorithms and processes described herein. The processor(s) 3508 can be configured to fetch and execute computer-readable processor-executable instructions stored in the computer-readable media 3510.

Depending on the configuration of the user device 3502, the computer-readable media 3510 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 3510 can include, but is not limited to, RAM, ROM, EEPROM, flash memory, solid-state storage, magnetic disk storage, optical storage, and/or other computer-readable media technology. Further, in some examples, the user device 3502 can access external storage, such as RAID storage systems, storage arrays, network attached storage, storage area networks, cloud storage, or any other medium that can be used to store information and that can be accessed by the processor(s) 3508 directly or through another computing device or network. Accordingly, the computer-readable media 3510 can be computer storage media able to store instructions, components or components that can be executed by the processor(s) 3508. Further, when mentioned, non-transitory computer-readable media exclude media such as energy, carrier signals, electromagnetic waves, and signals per se.

The computer-readable media 3510 can be used to store and maintain any number of functional components that are executable by the processor(s) 3508. In some implementations, these functional components comprise instructions or programs that are executable by the processor(s) 3508 and that, when executed, implement operational logic for performing the actions and services attributed above to the user device 3502. Functional components stored in the computer-readable media 3510 can include a user interface 3520 to enable users to interact with the user device 3502, and thus the server(s) 3504 and/or other networked devices. In at least one example, the user interface 3520 can be presented via a web browser, or the like. In other examples, the user interface 3520 can be presented via an application, such as a mobile application or desktop application, which can be provided by a service provider associated with the server(s) 3504, or which can be an otherwise dedicated application. In some examples, the user interface 3520 can be displayed to enable a user to initiate a cryptocurrency payment (or other digital asset transfer) to another user (e.g., to a merchant), to notify a recipient user that a payment (or other digital asset) has been received from a sending user, or to allow the recipient user to accept the transfer, to name just a few. In the context of previously described examples, the user interfaces depicted in FIGS. 3-28 are examples of a user interface 3520 that may be displayed via a display 3516 of a respective user device 3502. In at least one example, a user can interact with the user interface via touch input, spoken input, gesture, or any other type of input. The word “input” is also used to describe “contextual” input that may not be directly provided by the user via the user interface 3520. For example, user's interactions with the user interface 3520 are analyzed using, e.g., natural language processing techniques, to determine context or intent of the user, which may be treated in a manner similar to “direct” user input.

Depending on the type of the user device 3502, the computer-readable media 3510 can also optionally include other functional components and data, such as other components and data 3522, which can include programs, drivers, etc., and the data used or generated by the functional components. In addition, the computer-readable media 3510 can also store data, data structures and the like, that are used by the functional components. In accordance with the described techniques, for instance, the computer-readable media 3510 may also be used in variations to store one or more of the media content 126 and the model(s) 120 discussed above. Further, the user device 3502 can include many other logical, programmatic and physical components, of which those described are merely examples that are related to the discussion herein.

In at least one example, the computer-readable media 3510 can include additional functional components, such as an operating system 3524 for controlling and managing various functions of the user device 3502 and for enabling basic user interactions.

The communication interface(s) 3512 can include one or more interfaces and hardware components for enabling communication with various other devices, such as over the network(s) 3506 or directly. For example, communication interface(s) 3512 can enable communication through one or more network(s) 3506, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 3506 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 3502 can further include one or more input/output (I/O) devices 3514. The I/O devices 3514 can include speakers, a microphone, a camera, and various user controls (e.g., buttons, a joystick, a keyboard, a keypad, etc.), a haptic output device, and so forth. The I/O devices 3514 can also include attachments that leverage the accessories (audio-jack, USB-C, Bluetooth, etc.) to connect with the user device 3502.

In at least one example, user device 3502 can include a display 3516. Depending on the type of computing device(s) used as the user device 3502, the display 3516 can employ any suitable display technology. For example, the display 3516 can be a liquid crystal display, a plasma display, a light emitting diode display, an OLED (organic light-emitting diode) display, an electronic paper display, or any other suitable type of display able to present digital content thereon. In at least one example, the display 3516 can be an augmented reality display, a virtually reality display, or any other display able to present and/or project digital content. In some examples, the display 3516 can have a touch sensor associated with the display 3516 to provide a touchscreen display configured to receive touch inputs for enabling interaction with a graphic interface presented on the display 3516. Accordingly, implementations herein are not limited to any particular display technology. Alternatively, in some examples, the user device 3502 may not include the display 3516, and information can be presented by other means, such as aurally, haptically, etc.

In addition, the user device 3502 can include sensor(s) 3518. The sensor(s) 3518 can include a GPS device able to indicate location information. Further, the sensor(s) 3518 can include, but are not limited to, an accelerometer, gyroscope, compass, proximity sensor, camera, microphone, and/or a switch.

In some examples, the GPS device can be used to identify a location of a user. In at least one example, the location of the user can be used by the service provider, described above, to provide one or more services. That is, in some examples, the service provider can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users and/or for sending users notifications regarding available appointments with merchant(s) located proximate to the users. In at least one example, location can be used for taking payments from nearby customers when they leave a geofence, or location can be used to initiate an action responsive to users 3114 enter a brick-and-mortar store of a merchant. Location can be used in additional or alternative ways as well.

Additionally, the user device 3502 can include various other components that are not shown, examples of which include removable storage, a power source, such as a battery and power control unit, a barcode scanner, a printer, a cash drawer, and so forth.

In addition, in some examples, the user device 3502 can include, be connectable to, or otherwise be coupled to a reader device 3526, for reading payment instruments and/or identifiers associated with payment objects. In some examples, as described above, the reader device 3526 can plug in to a port in the user device 3502, such as a microphone port, a headphone port, an audio-jack, a data port, or other suitable port. In additional or alternative examples, the reader device 3526 can be coupled to the user device 3502 via another wired or wireless connection, such as via a Bluetooth®, BLE, and so on. The reader device 3526 can include a read head for reading a magnetic strip of a payment card, and further can include encryption technology for encrypting the information read from the magnetic strip. Additionally or alternatively, the reader device 3526 can be an EMV payment reader, which in some examples, can be embedded in the user device 3502. Moreover, numerous other types of readers can be employed with the user device 3502 herein, depending on the type and configuration of the user device 3502.

The reader device 3526 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 3526 may include hardware implementation, such as slots, magnetic tracks, and rails with one or more sensors or electrical contacts to facilitate detection and acceptance of a payment instrument. That is, the reader device 3526 may include hardware implementations to enable the reader device 3526 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 3526 may also include a biometric sensor to receive and process biometric characteristics and process them as payment instruments, given that such biometric characteristics are registered with the payment service and connected to a financial account with a bank server.

The reader device 3526 may include processing unit(s), computer-readable media, a reader chip, a transaction chip, a timer, a clock, a network interface, a power supply, and so on. The processing unit(s) of the reader device 3526 may execute one or more components and/or processes to cause the reader device 3526 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 3526, the computer-readable media may include volatile memory (such as RAM), non-volatile memory (such as ROM, flash memory, miniature hard drive, memory card, or the like), or some combination thereof. In at least one example, the computer-readable media of the reader device 3526 may include at least one component for performing various functions as described herein.

The reader chip may perform functionalities to control the operations and processing of the reader device 3526. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock, which may provide a clock signal indicating a time. Furthermore, the reader chip may perform functionality to control the network interface, which may interface with the network(s) 3506, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 3526. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 3502, which can be a POS terminal, and the reader device 3526 are shown as separate devices, in additional or alternative examples, the user device 3502 and the reader device 3526 can be part of a single device, which may be a battery-operated device. In such an example, components of both the user device 3502 and the reader device 3526 may be associated with the single device. In some examples, the reader device 3526 can have a display integrated therewith, which can be in addition to (or as an alternative of) the display 3516 associated with the user device 3502.

The server(s) 3504 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 3504 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 3504 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 3504 can include one or more processors 3528, one or more computer-readable media 3530, one or more I/O devices 3532, and one or more communication interfaces 3534. Each processor 3528 can be a single processing unit or a number of processing units, and can include single or multiple computing units or multiple processing cores. The processor(s) 3528 can be implemented as one or more microprocessors, microcomputers, microcontrollers, digital signal processors, central processing units, state machines, logic circuitries, and/or any devices that manipulate signals based on operational instructions. For example, the processor(s) 3528 can be one or more hardware processors and/or logic circuits of any suitable type specifically programmed or configured to execute the algorithms and processes described herein. The processor(s) 3528 can be configured to fetch and execute computer-readable instructions stored in the computer-readable media 3530, which can program the processor(s) 3528 to perform the functions described herein.

The computer-readable media 3530 can include volatile and nonvolatile memory and/or removable and non-removable media implemented in any type of technology for storage of information, such as computer-readable instructions, data structures, program components, or other data. Such computer-readable media 3530 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 3504, the computer-readable media 3530 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 3530 can be used to store any number of functional components that are executable by the processor(s) 3528. In many implementations, these functional components comprise instructions or programs that are executable by the processors 3528 and that, when executed, specifically configure the one or more processors 3528 to perform the actions attributed above to the service provider and/or payment processing service. Functional components stored in the computer-readable media 3530 can optionally include the model(s) 120 and one or more other components and data 3540. Examples of such other components include but are not limited to, the media content supervision platform 116 and the recommendation system 118, and examples of such other data include but are not limited to one or more of the media content 126, the characteristic(s) 128, the term(s) 130, and the model(s) 120.

In one or more implementations, the model(s) 120 can be trained using one or more machine-learning mechanisms. For example, a machine-learning mechanism can analyze training data (e.g., the media content 126, the characteristic(s) 128, and/or the term(s) 130) to train a data model that generates an output, which can be a recommended media content item(s) 136, a relevancy score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 3502 and/or the server(s) 3504 for use at a time after the data models have been trained (e.g., at runtime). Further, the one or more other components and data 3540 can include programs, drivers, etc., and the data used or generated by the functional components. Further, the server(s) 3504 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they that may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize an SDK to integrate third-party service provider functionality into its applications. That is, API(s) and/or SDK(s) can enable third-party developers to customize how their respective third-party applications interact with the service provider or vice versa.

The computer-readable media 3530 can additionally include an operating system 3542 for controlling and managing various functions of the server(s) 3504.

The communication interface(s) 3534 can include one or more interfaces and hardware components for enabling communication with various other devices, such as over the network(s) 3506 or directly. For example, communication interface(s) 3534 can enable communication through one or more network(s) 3506, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 3506 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 3504 can further be equipped with various I/O devices 3532. Such I/O devices 3532 can include a display, various user interface controls (e.g., buttons, joystick, keyboard, mouse, touch screen, biometric or sensory input devices, etc.), audio speakers, connection ports and so forth.

In at least one example, the system 3500 can include a datastore 3544 that can be configured to store data that is accessible, manageable, and updatable. In some examples, the datastore 3544 can be integrated with the user device 3502 and/or the server(s) 3504. In other examples, as shown in FIG. 31, the datastore 3544 can be located remotely from the server(s) 3504 and can be accessible to the server(s) 3504. The datastore 3544 can comprise multiple databases and/or servers connected locally and/or remotely via the network(s) 3506.

In at least one example, the datastore 3544 can store user profiles, which can include merchant profiles, customer profiles, and so on. Alternatively or additionally, the datastore 3544 can store the media content 126 and/or model(s) 120 for access over the network(s) 3506 by various user devices 3502 and/or server(s) 3504.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

Furthermore, in at least one example, the datastore 3544 can store inventory database(s) and/or catalog database(s). As described above, an inventory can store data associated with a quantity of each item that a merchant has available to the merchant. Furthermore, a catalog can store data associated with items that a merchant has available for acquisition. The datastore 3544 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, by a media content platform, a request from an artist entity to enable access to a media content item of the artist entity, the request including one or more terms that control use of the media content item;
listing the media content item on the media content platform, the listing enabling the media content item to be accessed via the media content platform and associating the media content item with one or more characteristics of the media content item and the one or more terms;
surfacing, to a supervisor entity via a user interface of the media content platform, a subset of media content items from media content items that are available for access, the subset of media content items that are surfaced including the media content item;
receiving, via the user interface of the media content platform, a selection of the media content item for licensing by the supervisor entity, the selection accepting the one or more terms that control use of the media content item; and
providing, to the supervisor entity, the media content item and a license for accessing the media content item that includes the one or more terms.

2. The computer-implemented method of claim 1, wherein the one or more terms include one or more of:
an amount of time that the supervisor entity is permitted to use the media content item as part of a compilation of media content;
one or more locations where the supervisor entity is permitted to use the media content item as part of the compilation of media content;
one or more channels where the supervisor entity is permitted to use the media content item as part of the compilation of media content; or
one or more mediums that the media content item is permitted to be incorporated.

3. The computer-implemented method of claim 1, further comprising processing the media content item by one or more models using machine learning to determine a portion of the media content item to surface for licensing.

4. The computer-implemented method of claim 1, further comprising:
analyzing the media content item by one or more models using machine learning to generate one or more recommended terms that control use of the media content item; and
surfacing the one or more recommended terms that control use of the media content item to the artist entity via a user interface.

5. The computer-implemented method of claim 1, wherein the surfacing further comprises:
receiving an additional request from the supervisor entity to locate media content items that are available for access, the additional request including one or more characteristics of media content that the supervisor entity is searching for to use in a compilation;
matching, by one or more models using machine learning, media content items that are available for access based on the one or more characteristics of the additional request; and
surfacing, to the supervisor entity via the user interface of the media content platform, the matching media content items.

6. The computer-implemented method of claim 1, further comprising automatically generating the license based on the one or more terms included with the request from the artist entity.

7. A computer-implemented method comprising:
receiving, by a media content platform, a request from an artist entity to enable access to a media content item of the artist entity;
displaying, by media content platform, a user interface configured to enable the artist entity to define one or more terms that control access to the media content item;
receiving, via the user interface displayed by the media content platform, user input defining the one or more terms that control access to the media content item;
listing the media content item on the media content platform, the listing enabling the media content item to be accessed via the media content platform; and
outputting, to the artist entity, a notification that a supervisor entity has selected the media content item for access.

8. The computer-implemented method of claim 7, wherein the notification includes an indication of which of the one or more terms were agreed to by the supervisor entity.

9. The computer-implemented method of claim 7, wherein the one or more terms include at least one of:
an amount of time that the supervisor entity is permitted to use the media content item as part of a compilation of media content;
one or more locations where the supervisor entity is permitted to use the media content item as part of the compilation of media content;
one or more channels where the supervisor entity is permitted to use the media content item as part of the compilation of media content; or
one or more mediums that the media content item is permitted to be incorporated.

10. The computer-implemented method of claim 7, further comprising:
analyzing the media content item by one or more models using machine learning to generate one or more recommended terms that control access to the media content item; and
surfacing the one or more recommended terms that control access to the media content item to the artist entity via the user interface.

11. The computer-implemented method of claim 10, wherein the one or more recommended terms include a recommended amount of time that the supervisor entity is permitted to use the media content item as part of a compilation of media content.

12. The computer-implemented method of claim 10, wherein the one or more recommended terms include one or more recommended channels where the supervisor entity is permitted to use the media content item as part of a compilation of media content.

13. The computer-implemented method of claim 10, wherein the one or more recommended terms include one or more recommended mediums that the media content item is permitted to be incorporated.

14. The computer-implemented method of claim 10, wherein the user input defining the one or more terms includes a selection of at least one of the one or more recommended terms.

15. A computer-implemented method comprising:
receiving, by a media content platform, a request from a supervisor entity to locate media content items available for licensing, the request including one or more characteristics of media content that the supervisor entity is searching for to use in a compilation;
surfacing, by the media content platform via a user interface, recommended media content items matching the one or more characteristics included in the request;
receiving, by the media content platform, a selection of a media content item from the recommended media content items surfaced via the user interface, the selection accepting one or more terms that control use of the media content item; and
providing, to the supervisor entity, the media content item and a license to use the media content item that includes the one or more terms.

16. The computer-implemented method of claim 15, further comprising automatically generating the license based on the one or more terms included with a request received from an artist entity.

17. The computer-implemented method of claim 15, wherein the one or more terms include at least one of an amount of time that the supervisor entity is permitted to use the media content item as part of a compilation of media content.

18. The computer-implemented method of claim 15, wherein the one or more terms include at least one of an amount of time that the supervisor entity is permitted to use the media content item as part of a compilation of media content.

19. The computer-implemented method of claim 15, wherein the one or more terms include one or more channels where the supervisor entity is permitted to use the media content item as part of the compilation of media content.

20. The computer-implemented method of claim 15, wherein the one or more terms include one or more mediums that the media content item is permitted to be incorporated.
